(19) United States
(12) Patent Application Publication
(10) Pub. No.: US 2026/0205842 A1
(43) Pub. Date: Jul. 16, 2026

(54) RADIO FREQUENCY (RF) SENSING USING AUTOMATIC GAIN CONTROL (AGC) SYMBOLS

(71) Applicant: QUALCOMM Incorporated, San Diego, CA (US)

(72) Inventors: Yuwei REN, Beijing (CN); Weimin DUAN, San Diego, CA (US); Huilin XU, Temecula, CA (US)

(21) Appl. No.: 19/135,070

(22) PCT Filed: Feb. 17, 2023
(86) PCT No.: PCT/CN2023/076718

§ 371 Date: Jun. 2, 2025

(51) Int. Cl. H04W 24/08; H04W 52/52

(52) U.S. Cl. CPC H04W 24/08; H04W 52/52

(57) ABSTRACT

In some implementations, a user equipment (UE) may obtain an indication of a sensing resource configuration comprising information regarding an orthogonal frequency division multiplexing (OFDM) slot having one or more automatic gain control (AGC) symbols in which radio frequency (RF) sensing is to be performed. The UE may perform RF sensing measurements of one or more transmitted RF signals in the one or more AGC symbols of the OFDM slot, in accordance with the sensing resource configuration.

### BACKGROUND

### 1. Field of Disclosure

The present disclosure relates generally to the field of radiofrequency (RF)-based sensing, or simply “RF sensing” in a wireless network such as a cellular network.

### 2. Description of Related Art

As the sophistication of cellular networks such as fourth generation (4G) and fifth generation (5G) cellular networks continues to increase, the functionality of such networks expands beyond mere data communication. Cellular networks can, for example, provide positioning functionality to determine a geographical location of a cellular mobile device (known as a “user equipment” (UE)) within a coverage region of the cellular network. Further, such networks are expanding into RF sensing to be able to detect the objects (including their location and speed) from reflections (or echoes) of RF signals reflecting from the objects. The RF signals used for RF sensing are typically specific to RF sensing, adding to the power usage and overhead of a cellular network.

### BRIEF SUMMARY

An example method of enabling radio frequency (RF) sensing by a user equipment (UE), according to this disclosure, may comprise obtaining, at the UE, an indication of a sensing resource configuration comprising information regarding an orthogonal frequency division multiplexing (OFDM) slot having one or more automatic gain control (AGC) symbols in which RF sensing is to be performed. The method also may comprise performing, at the UE, RF sensing measurements of one or more transmitted RF signals in the one or more AGC symbols of the OFDM slot, in accordance with the sensing resource configuration.

An example method of enabling radio frequency (RF) sensing by a user equipment (UE), according to this disclosure, may comprise sending, from a network node to the UE, a sensing resource configuration comprising information regarding an orthogonal frequency division multiplexing (OFDM) slot having one or more automatic gain control (AGC) symbols in which RF sensing is to be performed. The method also may comprise receiving, at the network node from the UE, a report indicative of RF sensing measurements of one or more transmitted RF signals in the one or more AGC symbols of the OFDM slot. The method also may comprise sending, from the network node to the UE, an AGC symbol configuration determined based at least in part on the report.

An example user equipment (UE) comprising: a transceiver, a memory, one or more processors communicatively coupled with the transceiver and the memory, wherein the one or more processors are configured to obtain an indication of a sensing resource configuration comprising information regarding an orthogonal frequency division multiplexing (OFDM) slot having one or more automatic gain control (AGC) symbols in which RF sensing is to be performed. The one or more processors further may be configured to perform, with the transceiver, radio frequency (RF) sensing measurements of one or more transmitted RF signals in the one or more AGC symbols of the OFDM slot, in accordance with the sensing resource configuration.

An example network node comprising: a transceiver, a memory, one or more processors communicatively coupled with the transceiver and the memory, wherein the one or more processors are configured to send, via the transceiver to a user equipment (UE), a sensing resource configuration comprising information regarding an orthogonal frequency division multiplexing (OFDM) slot having one or more automatic gain control (AGC) symbols in which RF sensing is to be performed. The one or more processors further may be configured to receive, via the transceiver from the UE, a report indicative of RF sensing measurements of one or more transmitted RF signals in the one or more AGC symbols of the OFDM slot. The one or more processors further may be configured to send, in the transceiver to the UE, an AGC symbol configuration determined based at least in part on the report.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of aspects of a fifth generation (5G) new radio (NR) network related to positioning and radio frequency (RF) sensing, according to some embodiments.

FIG. 2 showing an example of a frame structure for NR and associated terminology.

FIG. 3A shows an example of a processing hardware architecture that can be used for performing an automatic gain control (AGC) procedure, according to an embodiment.

FIG. 3B is a timing diagram provided to illustrate how AGC power levels may be used, according to an embodiment.

FIG. 4A is a diagram of a scenario in which our variations may be greater than in a traditional cellular set up.

FIG. 4B is a timing diagram illustrating how AGC output power may ramp up over time, according to an embodiment.

FIG. 4C is a diagram of an example OFDM slot having AGC symbols.

FIG. 5 is a message flow diagram illustrating a process of performing RF sensing using AGC symbols, according to an embodiment.

FIGS. 6A and 6B are diagrams illustrating examples of how embodiments may utilize AGC symbols for sensing in both sidelink Mode 1 and sidelink Mode 2.

FIG. 7 is a diagram illustrating an example of how sensing may be used to assist and AGC configuration, according to an embodiment.

FIG. 8 is a message flow diagram of an example process of configuring and performing sensing, which may be used by embodiments herein.

FIG. 9A is a timing diagram illustrating how joint sensing processing may be performed across multiple slots, according to an embodiment.

FIG. 9B is a graph of filter power levels and states of AGC corresponding to input power at the antenna of the receiving device, according to an embodiment.

FIGS. 10A and 10B are timing diagrams that illustrate techniques for reporting sensing measurement information by a receiving device, according to some embodiments.

FIG. 11 is a message flow diagram of a process for reporting sensing information to the network, according to an embodiment.

FIG. 12 is a diagram of several AGC slot formats that may be used for sensing, according to some embodiments.

FIG. 13A is a table illustrating how a network may predefine a slot format with different AGC symbols, according to an embodiment.

FIGS. 13B and 13C are timing diagrams illustrating possible usage for AGC may be impacted by symbol length and subcarrier spacing (STS).

FIG. 14 is a message flow diagram of a process of using AGC symbols for RF sensing between two nodes operating in sidelink Mode 2.

FIG. 15 is a method of enabling RF sensing by a UE, according to an embodiment.

FIG. 16 is another method of enabling RF sensing by the UE, according to an embodiment.

FIG. 17 is a block diagram of an embodiment of a UE.

FIG. 18 is a block diagram of an embodiment of a computer system.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “positioning reference signals,” “reference signals for positioning,” and the like may be used to refer to signals used for positioning of a mobile device, such as a user equipment (UE) in a 5G new radio (NR) network. As described in more detail herein, such signals may comprise any of a variety of signal types but may not necessarily be limited to a Positioning Reference Signal (PRS) as defined in relevant wireless standards. Additionally, unless otherwise specified, references to “sensing reference signals,” “reference signals for sensing,” and the like may be used to refer to signals used for RF sensing (also generically referred to herein as “sensing”) as described herein. A signal used for RF sensing and/or positioning may be generally referred to herein as a reference signal (RS). As described in more detail herein, such signals may comprise any of a variety of signal types but may not necessarily be limited to signals solely used for RF sensing. Moreover, an RS may be used for communication and/or other purposes, in addition or as an alternative to sensing and/or positioning.

As previously noted, RF sensing is being contemplated for use in various applications, including wireless networks such as cellular networks. However, RF sensing often utilizes specific resources dedicated to sensing, resulting in additional resource to use. Embodiments herein address these and other issues by leveraging orthogonal frequency-division multiplexing (OFDM) symbols used for automatic gain control (AGC) for RF sensing. Furthermore, according to some embodiments, RF sensing can be used to increase the efficiency of AGC symbols, allowing for more accurate determination of an AGC symbol length/number of AGC symbols and/or OFDM slot format for AGC.

Embodiments herein may provide one or more of the following advantages. Embodiments herein may provide for an increased efficiency in the usage of bandwidth resources in a wireless network for RF sensing. Additionally or alternatively, embodiments herein me provide for increased efficiency in AGC symbol determination and usage. A person of ordinary skill in the art will appreciate additional or alternative and advantages from the embodiments described herein. Embodiments are provided in detail after a discussion of relevant technology.

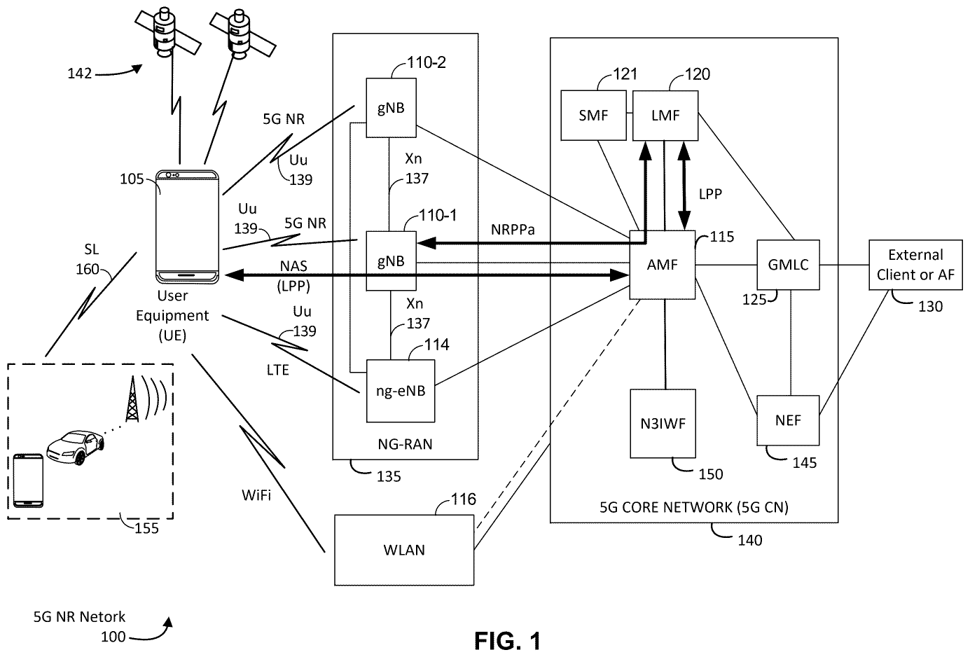

FIG. 1 is a diagram of aspects of a 5G NR network 100 related to positioning and RF sensing, illustrating an embodiment of a wireless system capable of performing RF sensing using automatic gain control (AGC) symbols, as described herein. The 5G NR network 100 may be configured to enable wireless communication, determine the location of a UE 105, perform RF sensing, or a combination thereof, by using access nodes, which may include NR NodeB (gNB) 110-1 and 110-2 (collectively and generically referred to herein as gNBs 110), ng-eNB 114, and/or WLAN 116. These access nodes can use RF signaling to enable the communication, implement one or more positioning methods, and/or implement RF sensing. Optionally, the 5G NR network 100 additionally may be configured to determine the location of a UE 105 by using an LMF 120 to implement the one or more positioning methods. The SMF 121 may coordinate RF sensing by the 5G NR network 100. Here, the 5G NR network 100 comprises a UE 105, and components of a 5G NR network comprising a Next Generation (NG) Radio Access Network (RAN) (NG-RAN) 135 and a 5G Core Network (5G CN) 140. A 5G NR network 100 may also be called a 5G network and/or an NR network; NG-RAN 135 may be referred to as a 5G RAN or as an NR RAN; and 5G CN 140 may be referred to as an NG Core network. Additional components of the 5G NR network 100 are described below. The 5G NR network 100 may include additional or alternative components.

The 5G NR network 100 may further utilize information from satellites 142. As previously indicated, satellites 142 may comprise GNSS satellites from a GNSS system like Global Positioning System (GPS) or similar system (e.g. GLONASS, Galileo, Beidou, Indian Regional Navigational Satellite System (IRNSS)). Additionally or alternatively, satellites 142 may comprise NTN satellites that may be communicatively coupled with the LMF 120 and may operatively function as a TRP (or TP) in the NG-RAN 135. As such, satellites 142 may be in communication with one or more gNB 110.

It should be noted that FIG. 1 provides only a generalized illustration of various components, any or all of which may be utilized as appropriate, and each of which may be duplicated or omitted as necessary. Specifically, although only one UE 105 is illustrated, it will be understood that many UEs (e.g., hundreds, thousands, millions, etc.) may utilize the 5G NR network 100. Similarly, the 5G NR network 100 may include a larger (or smaller) number of satellites 142, gNBs 110, ng-eNBs 114, Wireless Local Area Networks (WLANs) 116, Access and mobility Management Functions (AMF)s 115, external clients 130, and/or other components. The illustrated connections that connect the various components in the 5G NR network 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 105 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 105 may correspond to a cellphone, smartphone, laptop, tablet, personal data assistant (PDA), navigation device, Internet of Things (IoT) device, or some other portable or moveable device. Typically, though not necessarily, the UE 105 may support wireless communication using one or more Radio Access Technologies (RATs) such as using GSM, CDMA, W-CDMA, LTE, High-Rate Packet Data (HRPD), IEEE 802.11 Wi-Fi®, Bluetooth, Worldwide Interoperability for Microwave Access (WiMAX™), 5G NR (e.g., using the NG-RAN 135 and 5G CN 140), etc. The UE 105 may also support wireless communication using a WLAN 116 which (like the one or more RATs, and as previously noted with respect to FIG. 1) may connect to other networks, such as the Internet. The use of one or more of these RATs may allow the UE 105 to communicate with an external client 130 (e.g., via elements of 5G CN 140 not shown in FIG. 1, or possibly via a Gateway Mobile Location Center (GMLC) 125) and/or allow the external client 130 to receive location information regarding the UE 105 (e.g., via the GMLC 125). The external client 130 of FIG. 1 may correspond to external client 180 of FIG. 1, as implemented in or communicatively coupled with a 5G NR network.

The UE 105 may include a single entity or may include multiple entities, such as in a personal area network where a user may employ audio, video and/or data I/O devices, and/or body sensors and a separate wireline or wireless modem. An estimate of a location of the UE 105 may be referred to as a location, location estimate, location fix, fix, position, position estimate, or position fix, and may be geodetic, thus providing location coordinates for the UE 105 (e.g., latitude and longitude), which may or may not include an altitude component (e.g., height above sea level, height above or depth below ground level, floor level or basement level). Alternatively, a location of the UE 105 may be expressed as a civic location (e.g., as a postal address or the designation of some point or small area in a building such as a particular room or floor). A location of the UE 105 may also be expressed as an area or volume (defined either geodetically or in civic form) within which the UE 105 is expected to be located with some probability or confidence level (e.g., 67%, 95%, etc.). A location of the UE 105 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 135 shown in FIG. 1 may include gNBs 110. Pairs of gNBs 110 in NG-RAN 135 may be connected to one another (e.g., directly as shown in FIG. 1 or indirectly via other gNBs 110). The communication interface between base stations (gNBs 110 and/or ng-eNB 114) may be referred to as an Xn interface 137. Access to the 5G network is provided to UE 105 via wireless communication between the UE 105 and one or more of the gNBs 110, which may provide wireless communications access to the 5G CN 140 on behalf of the UE 105 using 5G NR. The wireless interface between base stations (gNBs 110 and/or ng-eNB 114) and the UE 105 may be referred to as a Uu interface 139. 5G NR radio access may also be referred to as NR radio access or as 5G radio access. In FIG. 1, the serving gNB for UE 105 is assumed to be gNB 110-1, although other gNBs (e.g. gNB 110-2) may act as a serving gNB if UE 105 moves to another location or may act as a secondary gNB to provide additional throughput and bandwidth to UE 105.

Base stations in the NG-RAN 135 shown in FIG. 1 may also or instead include a next generation evolved Node B, also referred to as an ng-eNB, 114. Ng-eNB 114 may be connected to one or more gNBs 110 in NG-RAN 135—e.g. directly or indirectly via other gNBs 110 and/or other ng-eNBs. An ng-eNB 114 may provide LTE wireless access and/or evolved LTE (eLTE) wireless access to UE 105. Some gNBs 110 (e.g. gNB 110-2) and/or ng-eNB 114 in FIG. 1 may be configured to function as positioning-only beacons which may transmit signals (e.g., Positioning Reference Signal (PRS)) and/or may broadcast assistance data to assist positioning of UE 105 but may not receive signals from UE 105 or from other UEs. Some gNBs 110 (e.g., gNB 110-2 and/or another gNB not shown) and/or ng-eNB 114 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 140, external client 130, or a controller) which may receive and store or use the data for positioning of at least UE 105. It is noted that while only one ng-eNB 114 is shown in FIG. 1, some embodiments may include multiple ng-eNBs 114. Base stations (e.g., gNBs 110 and/or ng-eNB 114) may communicate directly with one another via an Xn communication interface. Additionally or alternatively, base stations may communicate directly or indirectly with other components of the 5G NR network 100, such as the LMF 120 and AMF 115.

5G NR network 100 may also include one or more WLANs 116 which may connect to a Non-3GPP InterWorking Function (N3IWF) 150 in the 5G CN 140 (e.g., in the case of an untrusted WLAN 116). For example, the WLAN 116 may support IEEE 802.11 Wi-Fi access for UE 105 and may comprise one or more Wi-Fi APs (e.g., APs 130 of FIG. 1). Here, the N3IWF 150 may connect to other elements in the 5G CN 140 such as AMF 115. In some embodiments, WLAN 116 may support another RAT such as Bluetooth. The N3IWF 150 may provide support for secure access by UE 105 to other elements in 5G CN 140 and/or may support interworking of one or more protocols used by WLAN 116 and UE 105 to one or more protocols used by other elements of 5G CN 140 such as AMF 115. For example, N3IWF 150 may support IPSec tunnel establishment with UE 105, termination of IKEv2/IPSec protocols with UE 105, termination of N2 and N3 interfaces to 5G CN 140 for control plane and user plane, respectively, relaying of uplink (UL) and downlink (DL) control plane Non-Access Stratum (NAS) signaling between UE 105 and AMF 115 across an N1 interface. In some other embodiments, WLAN 116 may connect directly to elements in 5G CN 140 (e.g. AMF 115 as shown by the dashed line in FIG. 1) and not via N3IWF 150. For example, direct connection of WLAN 116 to 5GCN 140 may occur if WLAN 116 is a trusted WLAN for 5GCN 140 and may be enabled using a Trusted WLAN Interworking Function (TWIF) (not shown in FIG. 1) which may be an element inside WLAN 116. It is noted that while only one WLAN 116 is shown in FIG. 1, some embodiments may include multiple WLANs 116.

Access nodes may comprise any of a variety of network entities enabling communication between the UE 105 and the AMF 115. As noted, this can include gNBs 110, ng-eNB 114, WLAN 116, and/or other types of cellular base stations. However, access nodes providing the functionality described herein may additionally or alternatively include entities enabling communications to any of a variety of RATs not illustrated in FIG. 1, which may include non-cellular technologies. Thus, the term “access node,” as used in the embodiments described herein below, may include but is not necessarily limited to a gNB 110, ng-eNB 114 or WLAN 116.

In some embodiments, an access node, such as a gNB 110, ng-eNB 114, and/or WLAN 116 (alone or in combination with other components of the 5G NR network 100), may be configured to, in response to receiving a request for location information from the LMF 120, obtain location measurements of uplink (UL) signals received from the UE 105) and/or obtain downlink (DL) location measurements from the UE 105 that were obtained by UE 105 for DL signals received by UE 105 from one or more access nodes. As noted, while FIG. 1 depicts access nodes (gNB 110, ng-eNB 114, and WLAN 116) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 105, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 135 and the EPC corresponds to 5GCN 140 in FIG. 1. The methods and techniques described herein for obtaining a civic location for UE 105 may be applicable to such other networks.

The gNBs 110 and ng-eNB 114 can communicate with an AMF 115, which, for positioning functionality, communicates with an LMF 120. The AMF 115 may support mobility of the UE 105, including cell change and handover of UE 105 from an access node (e.g., gNB 110, ng-eNB 114, or WLAN 116) of a first RAT to an access node of a second RAT. The AMF 115 may also participate in supporting a signaling connection to the UE 105 and possibly data and voice bearers for the UE 105. The LMF 120 may support positioning of the UE 105 using a CP location solution when UE 105 accesses the NG-RAN 135 or WLAN 116 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhanced Cell ID (ECID), angle of arrival (AoA), angle of departure (AoD), WLAN positioning, round trip signal propagation delay (RTT), multi-cell RTT, and/or other positioning procedures and methods. The LMF 120 may also process location service requests for the UE 105, e.g., received from the AMF 115 or from the GMLC 125. The LMF 120 may be connected to AMF 115 and/or to GMLC 125. In some embodiments, a network such as 5GCN 140 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 105's location) may be performed at the UE 105 (e.g., by measuring downlink PRS (DL-PRS) signals transmitted by wireless nodes such as gNBs 110, ng-eNB 114 and/or WLAN 116, and/or using assistance data provided to the UE 105, e.g., by LMF 120).

The Gateway Mobile Location Center (GMLC) 125 may support a location request for the UE 105 received from an external client 130 and may forward such a location request to the AMF 115 for forwarding by the AMF 115 to the LMF 120. A location response from the LMF 120 (e.g., containing a location estimate for the UE 105) may be similarly returned to the GMLC 125 either directly or via the AMF 115, and the GMLC 125 may then return the location response (e.g., containing the location estimate) to the external client 130.

A Network Exposure Function (NEF) 145 may be included in 5GCN 140. The NEF 145 may support secure exposure of capabilities and events concerning 5GCN 140 and UE 105 to the external client 130, which may then be referred to as an Access Function (AF) and may enable secure provision of information from external client 130 to 5GCN 140. NEF 145 may be connected to AMF 115 and/or to GMLC 125 for the purposes of obtaining a location (e.g. a civic location) of UE 105 and providing the location to external client 130.

As further illustrated in FIG. 1, the LMF 120 may communicate with the gNBs 110 and/or with the ng-eNB 114 using an NR Positioning Protocol annex (NRPPa) as defined in 3GPP Technical Specification (TS) 38.455. NRPPa messages may be transferred between a gNB 110 and the LMF 120, and/or between an ng-eNB 114 and the LMF 120, via the AMF 115. As further illustrated in FIG. 1, LMF 120 and UE 105 may communicate using an LTE Positioning Protocol (LPP) as defined in 3GPP TS 37.355. Here, LPP messages may be transferred between the UE 105 and the LMF 120 via the AMF 115 and a serving gNB 110-1 or serving ng-eNB 114 for UE 105. For example, LPP messages may be transferred between the LMF 120 and the AMF 115 using messages for service-based operations (e.g., based on the Hypertext Transfer Protocol (HTTP)) and may be transferred between the AMF 115 and the UE 105 using a 5G NAS protocol. The LPP protocol may be used to support positioning of UE 105 using UE assisted and/or UE based position methods such as A-GNSS, RTK, TDOA, multi-cell RTT, AoD, and/or ECID. The NRPPa protocol may be used to support positioning of UE 105 using network-based position methods such as ECID, AoA, uplink TDOA (UL-TDOA) and/or may be used by LMF 120 to obtain location related information from gNBs 110 and/or ng-eNB 114, such as parameters defining DL-PRS transmission from gNBs 110 and/or ng-eNB 114.

In the case of UE 105 access to WLAN 116, LMF 120 may use NRPPa and/or LPP to obtain a location of UE 105 in a similar manner to that just described for UE 105 access to a gNB 110 or ng-eNB 114. Thus, NRPPa messages may be transferred between a WLAN 116 and the LMF 120, via the AMF 115 and N3IWF 150 to support network-based positioning of UE 105 and/or transfer of other location information from WLAN 116 to LMF 120. Alternatively, NRPPa messages may be transferred between N3IWF 150 and the LMF 120, via the AMF 115, to support network-based positioning of UE 105 based on location related information and/or location measurements known to or accessible to N3IWF 150 and transferred from N3IWF 150 to LMF 120 using NRPPa. Similarly, LPP and/or LPP messages may be transferred between the UE 105 and the LMF 120 via the AMF 115, N3IWF 150, and serving WLAN 116 for UE 105 to support UE assisted or UE based positioning of UE 105 by LMF 120.

Positioning of the UE 105 and/or sensing by the UE 105 in a 5G NR system 100 further may utilize RF signals between the UE 105 and one or more other wireless devices 155 via a sidelink connection SL 160. As shown in FIG. 1, the one or more other wireless devices 155 may comprise any of a variety of different device types, including mobile phone, vehicle, roadside units (RSU), other device types, or any combination thereof. For sensing and/or positioning, signals may be sent via SL 160 to the UE 105 from the one or more other wireless devices 155, to the one or more other wireless devices 155 from the UE 105, or both. Various signals may be used for sensing and/or positioning, which are generally referred to herein as reference signals (RSs). In some instances of positioning of the UE 105, the position of at least one of the one or more of the other wireless devices 155 may be determined at the same time (e.g., in the same positioning session) as the position of the UE 105. In some embodiments, the LMF 120 may coordinate the transmission of positioning signals and/or SMF 121 may coordinate the transmission of RF sensing signals via SL 160 between the UE 105 and the one or more other wireless devices 155. Additionally or alternatively, the UE 105 and the one or more other wireless devices 155 may coordinate a positioning and/or RF sensing session between themselves, without an LMF 120/SMF 121 or even a Uu connection 139 to an access node of the NG-RAN 135. To do so, the UE 105 and the one or more other wireless devices 155 may communicate messages via the SL 160. In some scenarios, the one or more other wireless devices 155 may have a Uu connection 139 with an access node of the NG-RAN 135 and/or Wi-Fi connection with WLAN 116 when the UE 105 does not. In such instances, the one or more other wireless devices 155 may operate as relay devices, relaying communications to the network (e.g., LMF 120 and/or SMF 121) from the UE 105. In such instances, a plurality of other wireless devices 155 may form a chain between the UE 105 and the access node.

According to some embodiments, such as when the UE 105 comprises and/or is incorporated into a vehicle, a form of D2D communication used by the UE 105 may comprise vehicle-to-everything (V2X) communication, which may be conveyed using SL 160. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The UE 105 illustrated in FIG. 1 may correspond to a component or device on a vehicle, RSU, or other V2X entity that is used to communicate V2X messages. In embodiments in which V2X is used, other wireless devices 155 may comprise a static communication/positioning device (e.g., an RSU), another vehicle, or a smartphone or other mobile device, or a combination thereof. It can be further noted that wireless devices 155 (which may include V2X devices), may be used together with access nodes 110, 114 and/or other wireless devices to perform positioning and/or RF sensing, according to some embodiments.

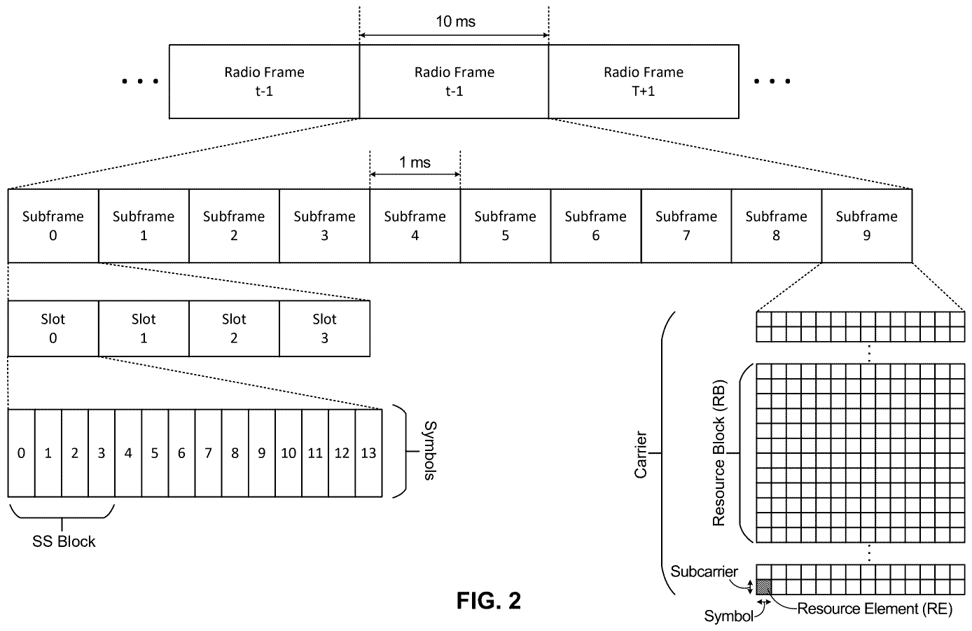

FIG. 2 is a diagram showing an example of a frame structure for NR and associated terminology, which can serve as the basis for physical layer communication between the UE 105 and base stations (e.g., via Uu links 139), other wireless devices (e.g., via SL 160), or a combination thereof. The transmission timeline for each of the downlink, uplink, and/or sidelink signals may be partitioned into units of radio frames. Each radio frame may have a predetermined duration (e.g., 10 ms) and may be partitioned into 10 subframes, each of 1 ms, with indices of 0 through 9. Each subframe may include a variable number of slots depending on the subcarrier spacing. Each slot may include a variable number of symbol periods (e.g., 7 or 14 symbols) depending on the subcarrier spacing. The symbol periods in each slot may be assigned indices. A mini slot may comprise a sub slot structure (e.g., 2, 3, or 2 symbols). Additionally shown in FIG. 2 is the complete Orthogonal Frequency-Division Multiplexing (OFDM) of a subframe, showing how a subframe can be divided across both time and frequency into a plurality of Resource Blocks (RBs). A single RB can comprise a grid of Resource Elements (REs) spanning 12 subcarriers.

Each symbol in a slot may indicate a link direction (e.g., downlink (DL), uplink (UL), or flexible) or data transmission and the link direction for each subframe may be dynamically switched. The link directions may be based on the slot format. Each slot may include DL/UL data as well as DL/UL control information. In NR, a synchronization signal (SS) block is transmitted. The SS block includes a primary SS (PSS), a secondary SS (SSS), and a two symbol Physical Broadcast Channel (PBCH). The SS block can be transmitted in a fixed slot location, such as the symbols 0-3 as shown in FIG. 2. The PSS and SSS may be used by UEs for cell search and acquisition. The PSS may provide half-frame timing, the SS may provide the cyclic prefix (CP) length and frame timing. The PSS and SSS may provide the cell identity. The PBCH carries some basic system information, such as downlink system bandwidth, timing information within radio frame, SS burst set periodicity, system frame number, etc.

In communications over a wireless interface (e.g., via Uu 139 and/or SL 160 interfaces), an automatic gain control (AGC) procedure in a receiving device is used to regulate the received signal strength at the input of the analog to digital converters (ADCs) in the RF chain of the receiving device such that the required signal to noise ratio (SNR) is met for proper decoding of the wireless signal. This AGC procedure may take a preestablished duration of time (which may be defined in relevant governing standards). For example, a receiving UE generally requires a specific duration of time to adjust the AGC state to adapt the signal strength.

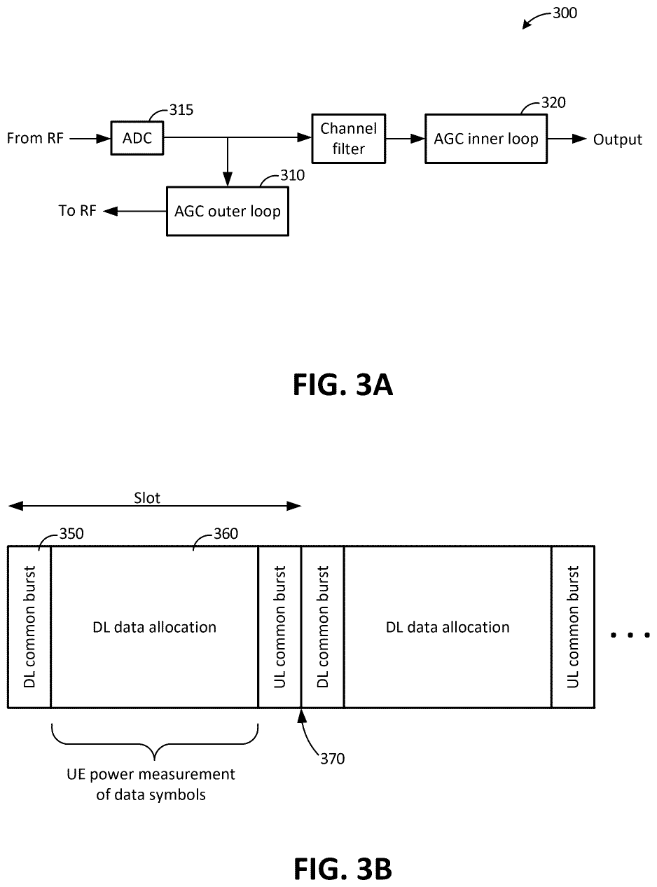

FIG. 3A shows an example of a processing hardware architecture 300 that can be used for performing the AGC procedure. The components in the architecture 300 may be implemented using hardware and/or software components of a wireless interface or transceiver of a wireless device (e.g., UE). As illustrated, to AGC loops may be used to adjust the AGC state. An outer loop 310 loop they operate on a wideband signal to modify the RF gain setting, based on the power level after ADC 315. An inner loop 320 may include an all-digital feedback loop that drives the power level to a pre-defined setpoint value that is output for decoding of received RF signals.

With respect to a Uu interface, a UE may maintain a different AGC power levels for different channels. These power levels may be stored by the UE and used to quickly adapt to power variations between different channels. The timing diagram shown in FIG. 3B, for example, illustrates how these power levels may be used. For example, in DL, a receiving UE can track the DL common burst 350 in continuous slots to converge the AGC for physical downlink control channel (PDCCH). Similarly, based on the grant in downlink control information (DCI), the UE can track the data channel 360 to converge the AGC state for physical downlink shared channel (PDSCH). The UE can then apply a new RF gain setting at the start of the cyclic prefix (CP) in the data region of the next lot (as shown at arrow 370). Generally, the power variation in Uu is limited. And, as illustrated, the UE may adjust its AGC state in a short time (e.g., in the CP or partial data). Even so, many designs propose to configure specific symbols for AGC, which can reserve enough time to adapt the dynamic power variation.

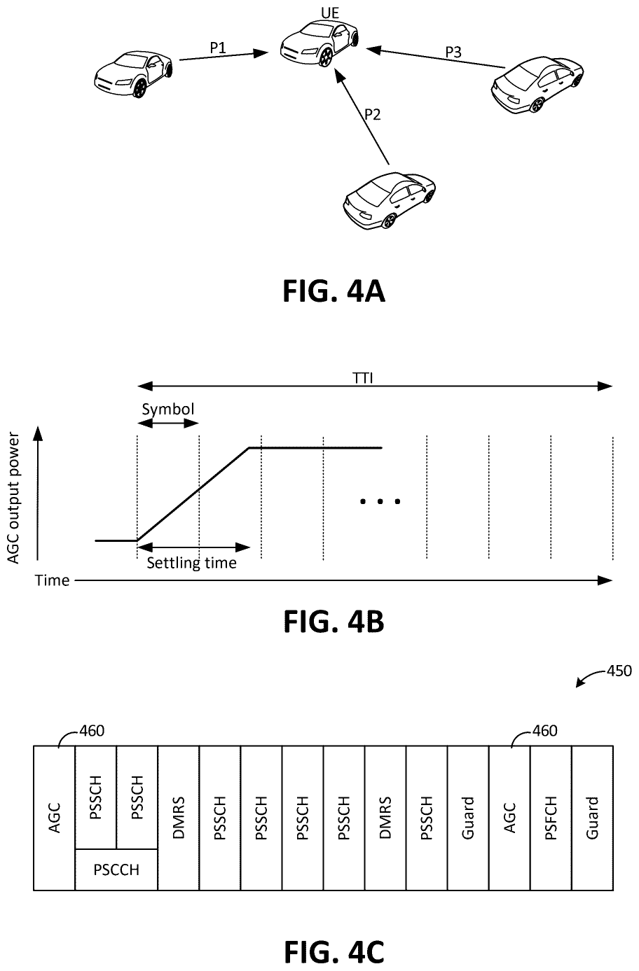

In sidelink communications, and particularly with respect to V2X, power variation may be much greater than in a Uu interface. As illustrated in FIG. 4A, this may be because, in general, a UE will receive signals via sidelink (e.g., P1, P2, and P3) from various transmission points. As such, the UE cannot anticipate from which transmission point it would receive a signal in the next transmission time interval (TTI). Thus, when performing AGC, it may take a relatively longer time to fit the amplified power level of the AGC into the dynamic range, as illustrated in FIG. 4B. (In FIG. 4B, the settling time, or time it takes for the UE to perform the AGC adjustment, is nearly two symbols.) This characteristic of sidelink makes it hard to perform AGC quickly.

With that in mind, additional AGC symbols can be introduced to allow for settling times. FIG. 4C illustrates an example slot 450 (comprising 14 sidelink symbols) that uses AGC symbols, in accordance with the current standards. In the current standard, additional AGC RS/repetition symbols 460 are defined before the physical sidelink control channel (PSCCH) or physical sidelink feedback channel (PSFCH). In 3GPP RAN4, the AGC settling time (e.g., time to set the AGC state, as indicated in FIG. 4B) is related to the subcarrier spacing (SCS). Example settling times are 35 μs for 15 kHz SCS, 35 μs for 30 kHz SCS, and 18 μs for 60 kHz SCS. Although the AGC state can be accurately adjusted, such specific symbols can lead the resource waste because the AGC symbols in each slot occupy a relatively large number of resources, even when the power variation is limited. So, in many scenarios, AGC settling time is not necessary. As described hereafter, some embodiments may address this by modifying AGC symbol length/but number based on RF sensing.

As noted, in V2X, the signal strength at a receiving UE may be changed rapidly subframe by subframe due to communications from various other UEs (e.g., as illustrated in FIG. 4A). Returning again to FIG. 4C, for example, the first symbol of a slot used in V2X communication may be employed for AGC tracking, and generally, such symbol is configured as one RS. In some embodiments, such an AGC RS can be used for AGC training, channel tracking, and used along with DMRS for channel estimation. An AGC RS additionally or alternatively may be used by the receiving UE to perform channel state information (CSI) acquisition and/or estimation.

Further, in addition or as an alternative to an RS, an AGC symbol may comprise a data symbol comprising a repetition of a data channel. That is, according to some embodiments, a data symbol can be used to adjust the AGC state and also provide a repetition of data. For example, one subframe may include (among other things) an AGC symbol and a data symbol, where the AGC symbol is the repetition of the data symbol, which provides diversity gain for decoding. In some instances, the AGC symbol can more accurately estimate an AGC state than an AGC RS.

It can be noted that the length of AGC resources may be more than one symbol, in some instances. Generally, as illustrated in a FIG. 4C, the length of AGC resources is one symbol. However, higher SCS may be configured with more AGC symbols. Further, as also shown in FIG. 4C, besides of the beginning of a slot 450, the symbol in front of the new channel (e.g., PSFCH) also may be configured as an AGC symbol 460. AGC may use a static configuration, and the AGC symbols may follow a periodical pattern. Such AGC symbols could be the duplicated symbols of data channel or can be an independent RS.

Embodiments herein can leverage the RS or repetitive data channel configured as AGC symbols to perform RF sensing. The AGC settling stage (e.g., settling time of FIG. 4B, used to set the AGC) can be difficult for communication because decoding typically requires AGC to be performed to produce high SNR. However, sensing can work with received signals before demodulation is performed by the receiving UE. With this in mind, embodiments herein can leverage legacy AGC symbols for sensing work. This can essentially enable RF sensing without requiring additional, specialized RF sensing transmissions.

Further, according to some embodiments, sensing information may assist to determine the length of AGC symbols. As discussed, different lengths of AGC symbols may be reserved to adapt to the power variation in some instances. In some scenarios (e.g., large power variation), the reserved resource may not be enough for a receiving device to adjust AGC state. Moreover, in some scenarios, the power variation may be limited, resulting in a reserved resource that is redundant and wasteful. As such, according to some embodiments, sensing may be used to detect/predict the power variation. Moreover, such sensing information may be used to assist the effective configuration in AGC.

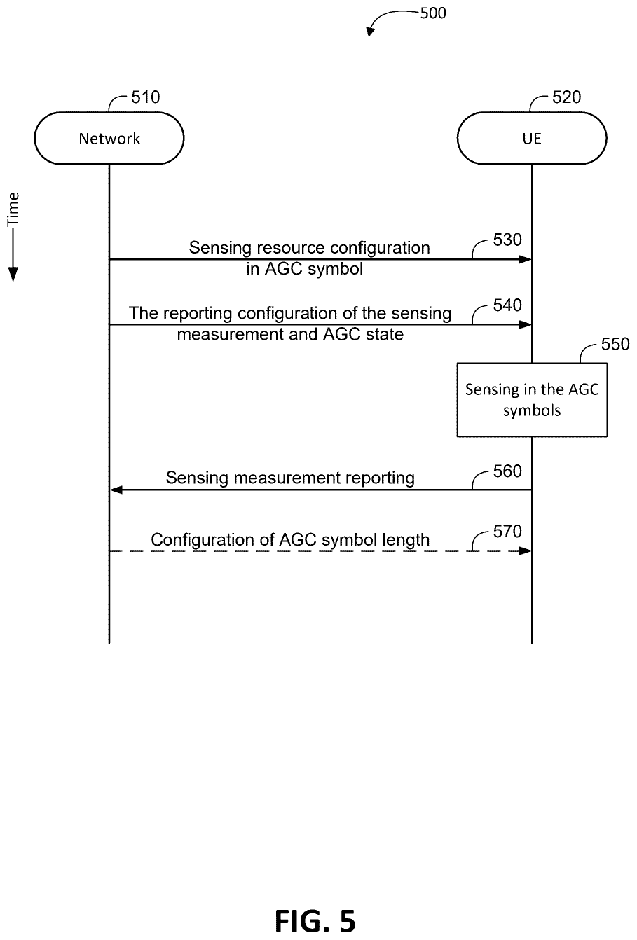

FIG. 5 is a message flow diagram illustrating a process 500 of performing RF sensing using AGC symbols, according to an embodiment. As illustrated, the process can take place between the network 510 (e.g., a network node, such as the SMF and/or a base station) and a UE 520. As illustrated, the process 500 may begin with the operations shown by arrow 530, in which the network 510 provides the UE 520 with a sensing resource configuration, to enable one or more AGC symbols for use in RF sensing. The operation at arrow 540 comprises the network configuring the UE 520 with respect to how the UE 520 is to report sensing measurement and AGC state information. At block 550, the UE 520 performs RF sensing in the AGC symbols (e.g., in accordance with the configuration provided by the network at arrow 530). After sensing, the UE 520 then reports sensing measurements obtained at block 550, as shown by arrow 560. As described hereafter, sensing may be used to adjust and AGC configuration (e.g., the number/length of AGC symbols in a slot). As such, according to some embodiments, the network 510 may (optionally) provide configuration of AGC symbol number/length, as indicated at arrow 570, based on the sensing measurement reporting received at arrow 560. Additional details and examples of this process 500 are provided in the embodiments described hereafter.

It can be noted that some embodiments may utilize AGC symbols for sensing without network configuration in the manner illustrated in FIG. 5. That is, configurations of UEs that communicate using sidelink may be executed using either Mode 1 or Mode 2. Mode 1 is a configuration in which one or more of the UEs or communicatively coupled with the network and we therefore receive configuration/coordination information from the network, and Mode 2 is a configuration in which UEs are not communicatively coupled with the network. With this in mind, embodiments may utilize AGC symbols for sensing not only in Mode 1 (in which case the process 500 of FIG. 5 could be used), but also Mode 2, in which no network configuration is used.

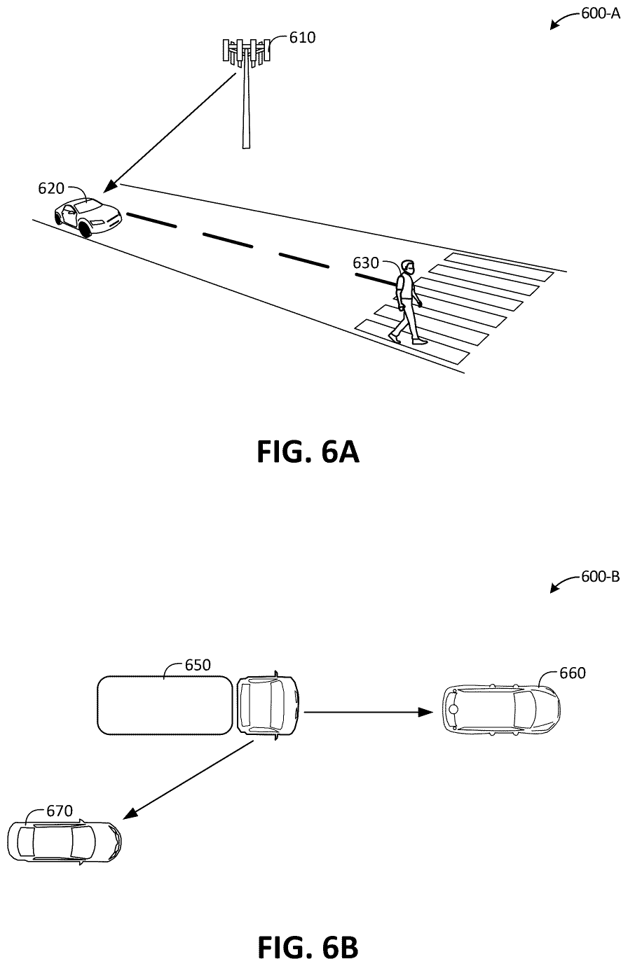

FIGS. 6A and 6B are diagrams illustrating examples of how embodiments may utilize AGC symbols for sensing in both sidelink Mode 1 and Mode 2. In these examples, a legacy AGC symbol can be used for quick sensing, which can largely reduce sensing latency without involving additional resource costs, because AGC symbols may be used regardless of whether sensing is performed. As described herein, terms such as “using AGC symbols for sensing,” “sensing in AGC symbols,” “performing sensing during AGC symbols,” or the like are meant to indicate how, according to embodiments described herein, echoes or reflections of RF signals transmitted during AGC symbols can be used for RF sensing.

A first scenario 600-A of FIG. 6A depicts a scenario in which a network-connected configuration (e.g., Mode 1) is used. In this example, a base station 610 may configure a vehicle 620 entering a danger-prone area to use an AGC symbol to sense it is surrounding and to estimate the range and velocity information. This could help the vehicle 620 detect an object (e.g., pedestrian 630) and avoid or mitigate a dangerous situation.

A second scenario 600-B of FIG. 6B depicts an overhead view of a scenario in which a non-network-connected configuration (e.g., Mode 2) is used. In this example, one vehicle 650 triggers the sensing and broadcasts a sensing configuration to nearby vehicles 660 and 670. Any car getting the information an perform the sensing in the AGC symbol. This can allow the nearby vehicles 660 and 670 to quickly detect the speed and range information of the vehicle 650 and/or other vehicles/objects, which can be useful for driving safety.

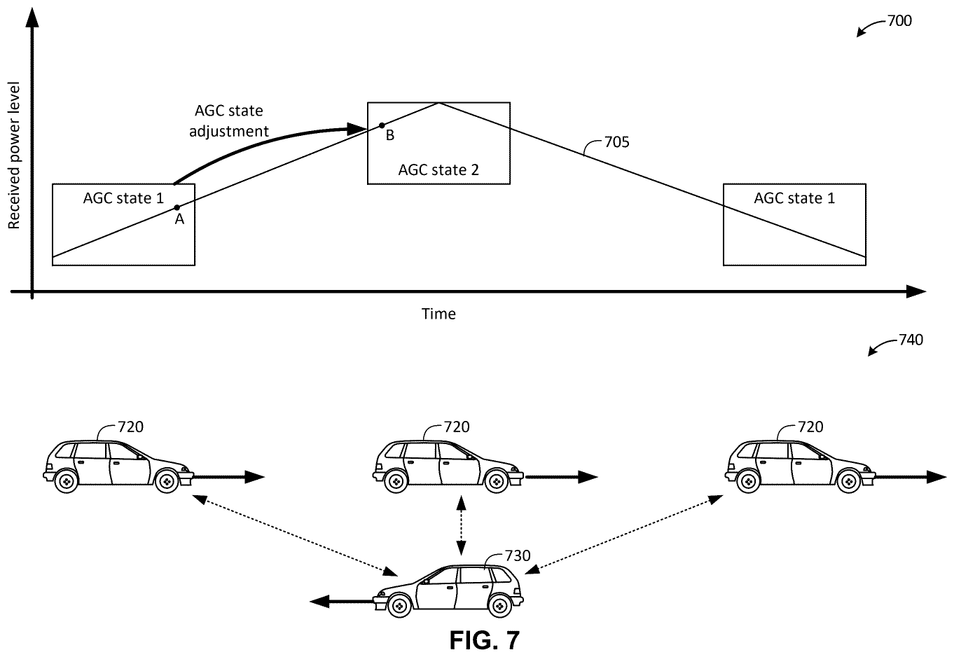

FIG. 7 is a diagram illustrating an example of how sensing may be used to assist and AGC configuration, according to an embodiment. In this diagram, the graph 700 plots a received power level 705 corresponding to power received over time by a first car 720 by a second car 730 (transmitting at a constant Tx power) in the scenario 740, in which the first car 720 and second car 730 past each other probably opposite directions. As shown in the graph 700, the power level 705 starts relatively low (because the second car 730 is relatively distant from the first car 720) and increases over time as the first car 720 and second car 730 get closer, then decreases as the first car 720 and second car 730 past each other and travel away from each other.

As illustrated in the graph, the first car 720 (or, more accurately, a UE of the first car 720) may need to adjust AGC states as the second car 730 approaches, then passes by the first car 720. For example, the first car 720 may need to adjust from AGC state 1 to AGC states 2 as the second car 730 approaches and received power increases from point A to point B. The first car 720 may then need to adjust back to AGC state 1 once the second car 730 passes by and begins traveling away from the first car 720.

Taking the AGC state adjustment from AGC state 1 to AGC state 2 (e.g., from received power level point A to point B) as an example, embodiments may enable the first car 720 to perform sensing to facilitate this adjustment. That is, during AGC symbols, the first car 720 may perform sensing to determine the location and velocity of the second car 730. With this information, the first car 720 can anticipate a continued increase in received power 705, given the direction of the second car's travel and its relative position with the first car 720.

If the anticipated change in received power is large enough, it may impact an AGC configuration. That is, although a single symbol may be initially allocated for AGC (e.g., as shown in the example slot 450 of FIG. 4C) if the anticipated power change (e.g., from AGC state 1 to AGC state 2) is large enough, an additional AGC symbol may be needed to give sufficient time (symbols) to allow the first car 720 to make the change. A similar technique may be used to anticipate smaller power changes. For example, if the anticipated power change is expected to be low (e.g., relatively stable power), then an AGC symbol may not be necessary at all and may be removed from the slot to avoid resource waste.

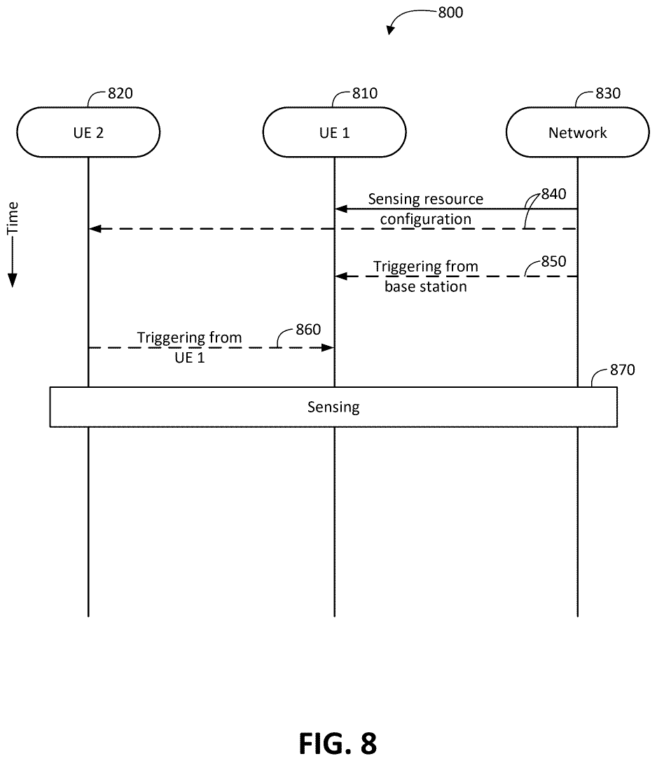

FIG. 8 is a message flow diagram of a process 800 of configuring and performing sensing, which may be used by embodiments herein. In this example, a first UE 810 may comprise a receiving device that performs sensing during AGC symbols using RF transmissions by the second UE 820 and/or a base station (or another wireless node) of the network 830 may transmit. As noted elsewhere herein, embodiments may be performed using sidelink Mode 1 (network connected) and/or sidelink Mode 2 (not network connected), depending on the scenario. Optional functionality (e.g., based on which mode is used) is illustrated by dashed arrows, and explained in further detail below.

It can be further noted that the network 830, as represented in FIG. 8, may represent different nodes within the network. An SMF, for example, may determine and provide the sensing configuration to the first UE 810 and (optionally) the second UE 820 (e.g., via a base station communicatively coupled with the UEs 810 and 820). Further, a base station (e.g., gNB) may be used to relay information from the SMF and (optionally) transmitted signals to be measured by the first UE 810 for sensing.

The process 800 may begin with the network 830 providing a sensing resource configuration to the first UE 810 (e.g., the receiving device), as indicated at arrow 840. In embodiments in which a second UE 820 is used for sensing, the sensing resource configuration may be sent to the second UE 820 as well. The sensing resource configuration can provide information to enable the first UE 810 to perform sensing measurements during one or more AGC symbols transmitted by the network 830 and/or second UE 820. This information can include, for example, a sensing effective time duration where the AGC symbols can be used for the sensing (e.g., 20 ms or 30 ms). According to some embodiments, information sense to a transmitting device (second UE 820) may include a phase continuity request among the signal's transmission within the given time duration (e.g., within a sensing duration, a transmitting device should ensure the phase continuity among the sent AGC symbols). According to some embodiments, the sensing resource configuration provided by the network 830 may be conveyed using radio resource control (RRC) signaling. In alternative embodiments, another node type may send sensing resource configuration information if the network 830 is not available (e.g., when operating in Mode 2), such as a configuring UE, RSU, or the like.

Once the resource configuration has been sent, the network 830 (e.g., via a base station) or the second UE 820 may dynamically trigger the sensing actions in the AGC symbols. That is, a base station of the network 830 may send a trigger for sensing (as shown by arrow 850) in Mode 1, and the second UE 820 may send a trigger for sensing (as shown by arrow 860) in Mode 2. According to some embodiments, this triggering may be based on the broadcast channels, and any adjacent nodes (e.g., UEs receiving the broadcast) may be enabled for sensing. Additionally or alternatively, triggering may be based on PDCCH (e.g., in Mode 1) or PSCCH (e.g., in Mode 2) to specifically trigger one UE for sensing. Once triggered, the sensing may be performed as indicated at block 870.

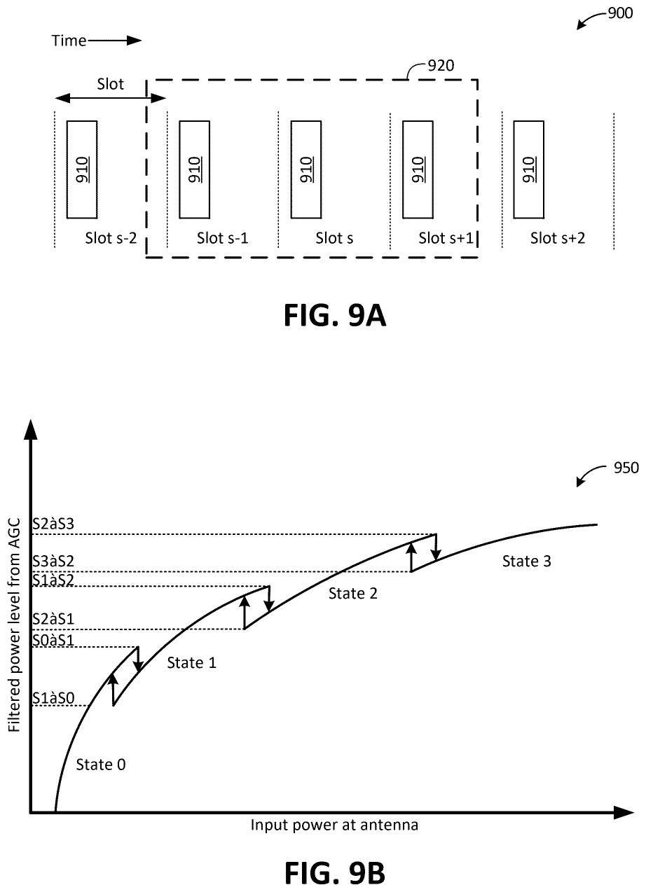

Based on the configuration provided in the process 800, phase continuity may be insured from the same transmitting UE (e.g., second UE 820). However, phase from different transmitting UEs may be difficult to align hard to align. To address these issues, some embodiments may implement the features discussed hereafter with respect to FIGS. 9A and 9B.

FIG. 9A is a timing diagram 900 illustrating how joint sensing processing may be performed across multiple slots. The diagram 900 illustrates a sequence of slots having AGC symbols, where block 910 represent measurements made by a receiving device in respective AGC symbols of a slot. According to some embodiments, a sensing observation window 920 may be proportional to the granularity of the speed estimation. Therefore, joint sensing processing may be enabled among the multiple sensing symbols, in which case phase continuity may be needed among measurements within the observation window 920.

To help ensure phase continuity within measurements (e.g., blocks 910) within an observation window 920, embodiments may compare AGC states of measurements may in) slots. That is, because received power from different transmitting devices (e.g., transmitting nodes such as other UEs or a base station) made widely different, a comparison of an AGC states of measurements made in different slots can indicate whether transmissions are from the same for different transmitting devices. If there is relatively little variation between measurements, this can be indicative of measurements of signals from the same transmitting device. Otherwise, large variation can be indicative of measurements of signals from different transmitting devices. Measurements determined to be from the same transmitting device may be assumed to have phase continuity and may be processed accordingly by the receiving device.

According to some embodiments, a predefined threshold, τ, for the AGC state variation (or the power variation) can be used to determine whether joint sensing processing can be performed with measurements across multiple slots. The threshold may be established by the network is provided to a receiving device (e.g., in a sensing configuration). If, in a measurement in an AGC symbol performed by the receiving device, the AGC state of the receiving device varies from the previous measurement by an amount that exceeds τ, the current sensing measurement can be assumed to be from a different transmitting device from the previous measurement. Otherwise, the current sensing measurement can be assumed to be from the same transmitting device, and phase continuity can be assumed. In this way, a receiving device can determine whether there is phase continuity for sensing within an observation window 920.

FIG. 9B is a graph 950 of filter power levels from AGC over input power at the antenna for a receiving device, provided to help illustrate how the predefined threshold predefined threshold, τ, may be used, according to some embodiments. In this example, the graph 950 illustrates four different AGC states (states 0-3), and the transitions between them. To help ensure smooth transitions from one state to another, there may be different thresholds for moving from a lower state to a higher state than for moving from the higher state to the lower state. For example, the transition up from state 0 state 1 occurs at a higher power level than the transition down from state 1 to state 0. (As illustrated, similar transitions may occur between other pairs of adjacent states.)

According to some embodiments, the threshold τ may be in terms of the filtered power level from AGC, which may be in terms of dB level. For example, in instances in which τ=3 dB, then for a measured power level Pₛ in an AGC symbol of slot s (e.g., of FIG. 9A), if Pₛ is larger than 2*Pₛ₋₁ (a 3 dB change from the previous slot, s−1), the receiving device can consider the measured signal in slot s as being transmitted from a different transmitting device than the measured signal in slot s−1.

Additionally or alternatively, the threshold τ may be in terms of AGC state index. For example, in instances in which when τ=1, then for an instance in which he AGC states changes from state 0 to state 2 between measurements made in slot s−1 and slot s, the receiving device can consider the measured signal in slot s as being transmitted from a different transmitting device than the measured signal in slot s−1, because the transition of 2 states is greater than the threshold value τ.

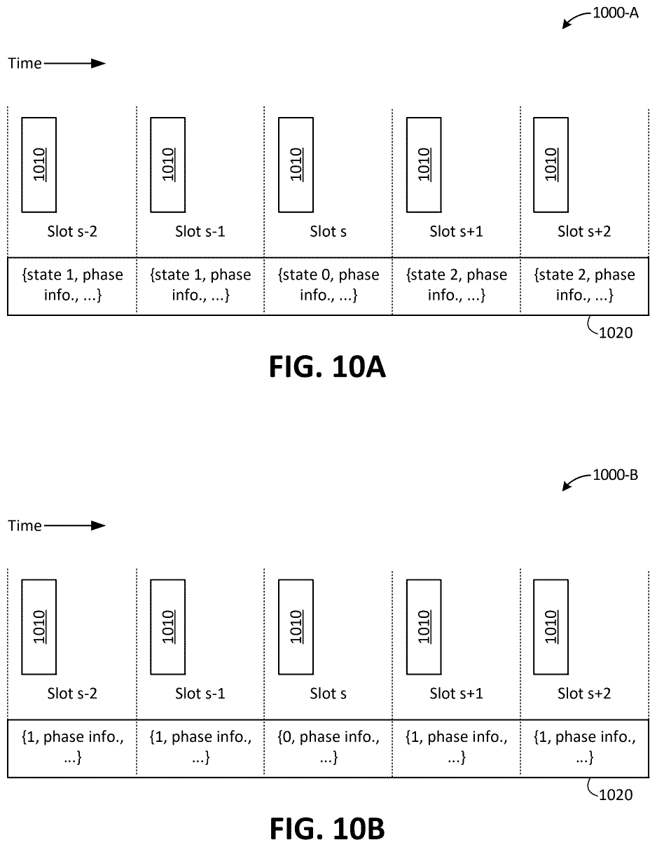

The way in which a receiving device reports sensing measurement information (e.g., at arrow 560 of FIG. 5, in accordance with reporting configuration received at arrow 540) may vary, depending on desired functionality. FIGS. 10A and 10B, discussed below, but examples of two different options for such reporting. Other techniques for reporting may be used in addition or as an alternative to those shown in FIGS. 10A and 10B. This can include different formatting, content, etc.

FIG. 10A is a timing diagram 1000-A that illustrates one technique for reporting sensing measurement information by a receiving device. Similar to diagram 900 of FIG. 9A, timing diagram 1000-A shows a series of successive slots (slot s−2 to slot s+2) in which sensing measurements are made in AGC symbols, as indicated at block 1010. Here, however, the information shown in block 1020 illustrates reporting information that may be provided for each respective slot. In accordance with this technique, for each sensing measurement, the receiving device reports and AGC state and sensing information (e.g., including the measured phase pattern).

FIG. 10B is another timing diagram 1000-B that illustrates a second technique for reporting sensing measurement information by a receiving device, similar to diagram 1000-A of FIG. 10A. In accordance with this technique, for each sensing measurement, the receiving device reports a single bit representative of phase continuity. In this example, bit 1 or a slot represents phase continuity with the measurement of the previous slot, whereas bit 0 indicates where there is no phase continuity. Here, too, additional sensing information such as measured phase pattern can be provided.

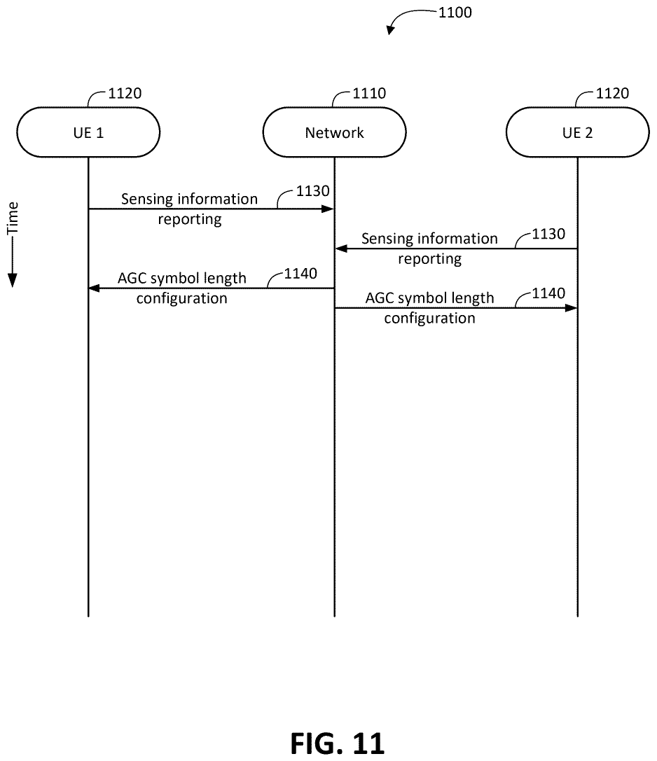

FIG. 11 is a message flow diagram of the process 1100 for reporting sensing information to the network, according to some embodiments. As noted in FIG. 5, sensing measurement reporting (arrow 560) may precede a configuration of AGC symbol length (e.g., number of symbols) (arrow 570). This can allow a customized AGC configuration for subsequent sensing based initial sensing information and may be repeated to enable ongoing dynamic AGC configuration. As illustrated, the process 1100 may be executed by a network 1110 (e.g., one or more network nodes such as an SMF and/or base station) and one or more UEs. As with other figures herein, FIG. 11 is provided as a nonlimiting example. This example is based on a network-connected sensing configuration, such as Mode 1 of sidelink and/or using a Uu interface between UEs and a base station. Alternative embodiments may enable non-network-connected sensing, such as in Mode 2 of sidelink, where the functionality of the network 1110 in the process 1100 may be replaced with a coordinating UE or other known (e.g., RSU).

The process 1100 may begin with UEs 1120 reporting sensing information to the network 1110, as indicated by arrows 1130. As indicated in previous embodiments, the contents of sensing information may vary, depending on desired functionality. According to some embodiments, the sensing information may include a number of targets within a detecting range (e.g., 40 m, 50 m, 60 m, 70 m, etc.), which may be based on UE sensing capability. Additionally or alternatively, sensing information may include a speed and/or range information (e.g., distance to the sensing UE) of each target. Based on the sensing information reported to the network 1110, the network can then configure the AGC symbol length, which it can provide to the UEs 1120 (which may include both transmitting UEs and receiving UEs for sensing), as indicated at arrow's 1140.

The frequency at which sensing information is reported and/or a configuration of AGC symbol length is provided by the network may vary, depending on desired functionality. For example, sensing information reporting may be configured to be provided by UEs 1120 periodically, in which case the network 1110 can adjust the AGC symbol length (and provide the corresponding configuration of the AGC symbol length adjustment) periodically, responsive to receiving the sensing information reported. Additionally or alternatively, a predefined threshold may be established where, based on certain triggers, sensing information can be reported by the UEs 1120, and a corresponding AGC symbol length configuration can be set by the network 1110. Predefined specials could be sensing a number of targets above a threshold number, sensing a target above a threshold speed or within a predetermined range of speed, or any combination thereof.

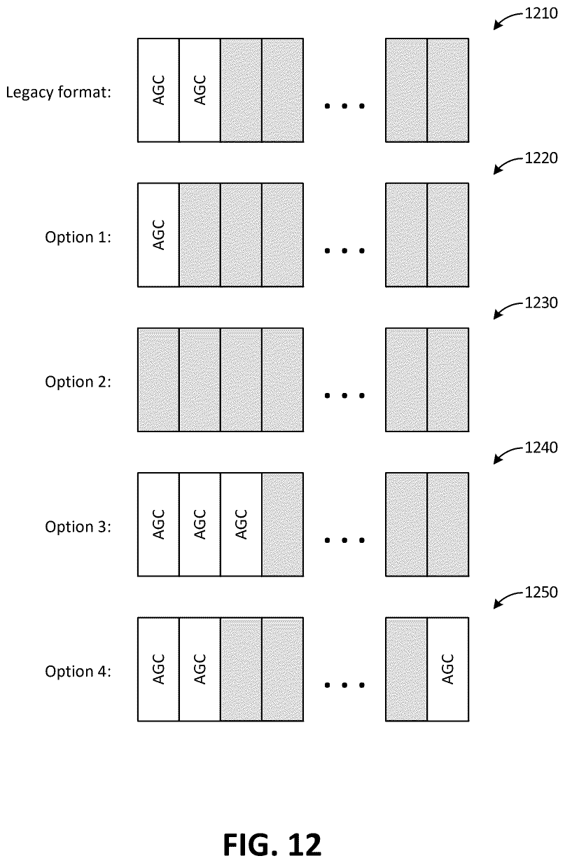

FIG. 12 is a diagram of several AGC slot formats that can be used for sensing, according to some embodiments. As previously noted, AGC slot formats may be configured by the network, and may be based on sensing information (e.g., from previous sensing) and/or measured power level. For example, based on sensing information reporting received by the network (e.g., at arrows 1130 in FIG. 11), the network can and AGC symbol length configuration and provide it to the UEs for subsequent sensing. As previously discussed, larger anticipated changes in received power may require longer/more AGC symbols, whereas smaller anticipated changes in received power may require fewer/less AGC symbols.

The options illustrated in FIG. 12 shows some examples of different slot formats that can be used for AGC sensing. In addition to a legacy format 1210, several other AGC format options 1220-1250 may be available, according to some embodiments. Compared with the legacy format 1210, the first option 1220 reduces the AGC symbol length (to 1 symbol), the second option 1230 disables the AGC symbol, the third option 1240 adds an additional AGC symbol in the beginning of the slot, and the fourth option 1250 adds an additional AGC or one Symbol in the last portion of the slot.

The selection of these options by the network (or configuring device) may be based on input from the UE. For example, a UE may indicate to the network whether an AGC symbol is needed or not for future sensing. This can be done, for example, by including a single bit in a message (e.g., sensing reporting). A value of “1” may indicate that no AGC symbol is needed, in which case the legacy AGC state will be reused and the default AGC symbol format (e.g., legacy format 1210) and be used for data transmission. Otherwise, a value of “0” may indicate that a UE requires an additional or alternative AGC time, which can trigger the use of one of the options 1220-1250 described above.

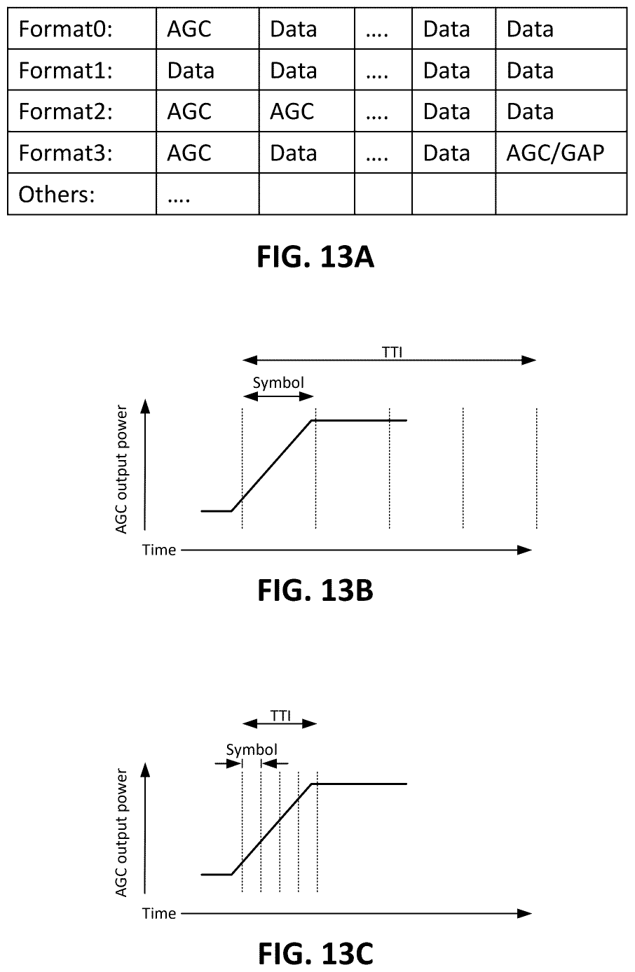

Depending on desired functionality, embodiments may implement one or more additional features with respect to AGC symbol formats figured and used for RF sensing. Examples of such features are described with respect to FIGS. 13A-13C.

FIG. 13A is a table illustrating how a network may predefine a slot format with different AGC symbols, according to an embodiment. That is, the data represented in this table may be communicated from a network to UEs for future reference. As shown, formats may be indexed to a number (e.g., Formats 0-3), and may be defined in the table (e.g., each column representing a symbol in the slot). Additionally or alternatively, this information may be adapted by applicable standard and pre-loaded onto UEs (e.g., rather than communicated to UEs by the network). When sending an AGC symbol length configuration to one or more UEs, the network (or other configuring device) may simply indicate the corresponding slot format index with the new AGC symbol length configuration.

According to some embodiments, AGC length may be based, at least in part, on SCS, which can impact symbol length. Higher SCS spacing results in shorter symbols. Thus, more symbols may be needed with higher SCS spacing to allow the AGC to shift from one state to another. FIG. 13B, for example, illustrates an AGC output power transition (e.g., from one AGC state to another) at an SCS of 15 kHz. FIG. 13C, on the other hand, illustrates a similar AGC output power transition, but with an SCS of 60 kHz. As can be seen, only one AGC symbol may be needed for the transition if the SCS is 15 kHz, whereas four AGC symbols may be needed if the SCS is 60 kHz.

According to some embodiments, the AGC symbol used in the slot formats provided herein could take on different formats, depending on desired functionality. For example, according to some embodiments, the AGC symbol may be a repeated data channel with the same power level as a previous repetition and/or an RS channel with the same power level. Additionally or alternatively, it may include a gap symbol that has a repeated data channel, RS, or which is blank.

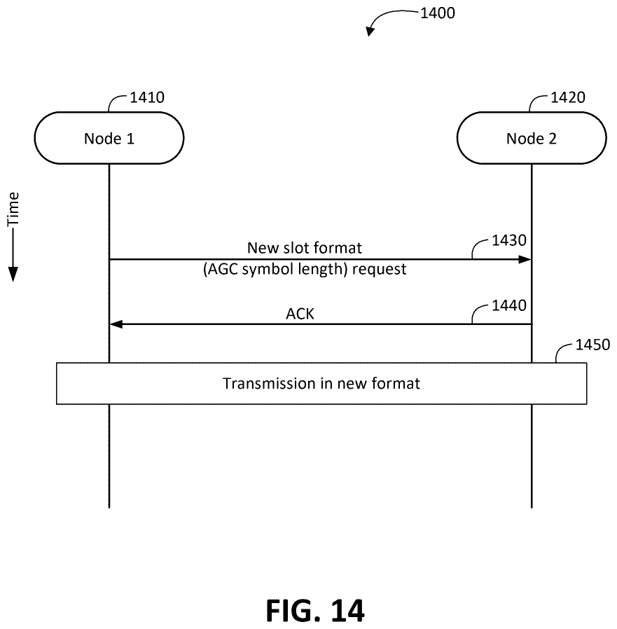

As previously indicated, sidelink configurations (including V2X) and operate in two modes. Mode 1 is a network-connected mode in which the network may control the configuration of AGC symbols for RF sensing. Mode 2 is a mode in which there is no network connection, but instead connected nodes (e.g., UEs/vehicles) may determine configurations with no network input in may transmit configurations to other nodes. An example of how AGC symbol configuration may be implemented in Mode 2 is provided in FIG. 14.

FIG. 14 is a message flow diagram of a process 1400 of using AGC symbols for RF sensing between two nodes operating in Mode 2. Here, a first node 1410 and second node 1420 may comprise UEs communicating via sidelink (e.g., vehicles communicating via V2X). In this process, the first node 1410 may send a request for a new slot format, shown by arrow 1430, indicative of a AGC symbol length (e.g., utilizing formats similar to those discussed with respect to FIGS. 12-13C). As previously noted, this communication between nodes may be made via PSCCH. The request sent by the first node 1410 may include a requested AGC symbol configuration, which may be in accordance with stage 2 sidelink control information (SCI-2). If the requested format is accepted by the second node 1420, the second node can then send an acknowledgment (ACK), as shown by arrow 1440. In some embodiments, the ACK may be sent via PSFCH. If the requested format is not accepted, a non-acknowledgment (NACK) may be sent. After the ACK is received, the first node 1410 and second node 1420, may perform sensing using the requested new format, as indicated at block 1450. For example, the second node 1420 may transmit the new slot format in one or more slots following the ACK, and the first node 1410 can perform sensing in the one or more AGC symbols of the new slot format.

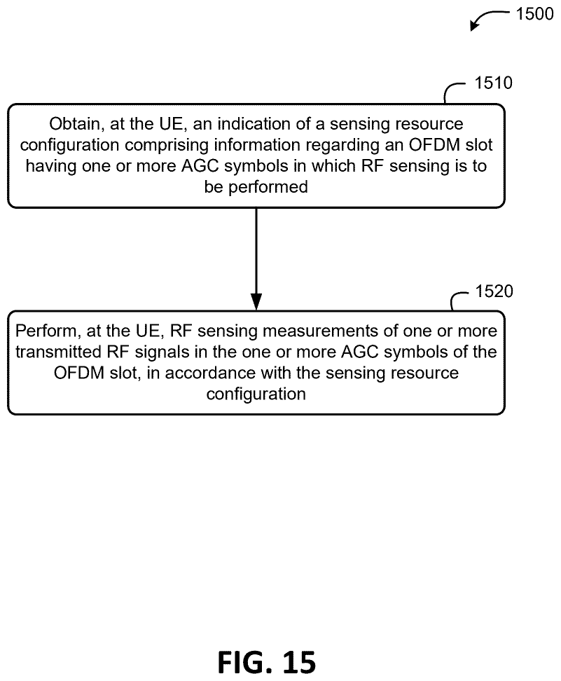

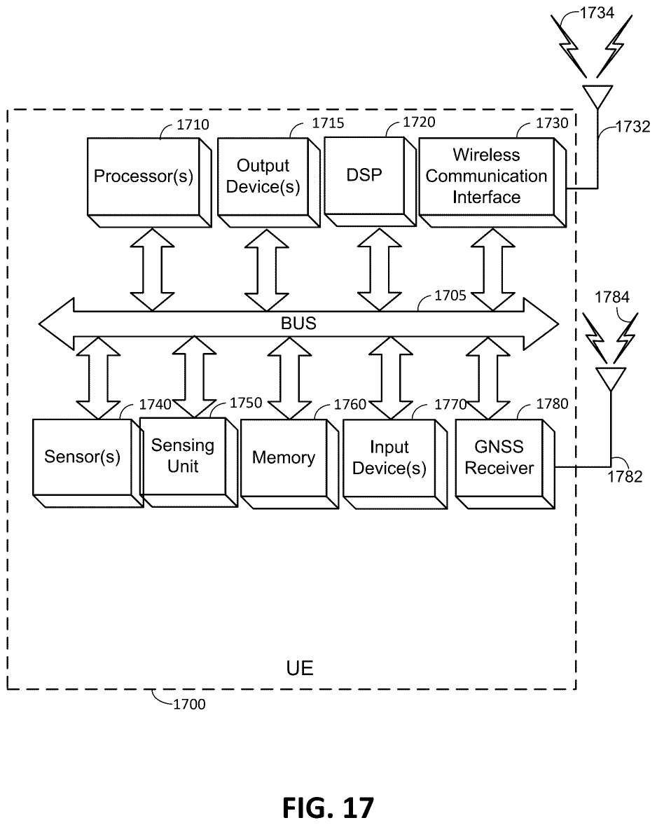

FIG. 15 is a flow diagram of a method 1500 of enabling RF sensing by a UE, according to an embodiment. The method 1500 may comprise aspects of the functionality of a UE as discussed in the embodiments above. As such, one or more of the operations in the blocks of FIG. 15 may be performed by hardware and/or software components of a UE. Example components of a UE are illustrated in FIG. 17, which is described in more detail below.

At block 1510, the functionality comprises obtaining, at the UE, an indication of a sensing resource configuration comprising information regarding an OFDM slot having one or more AGC symbols in which RF sensing is to be performed. As noted herein, the sensing resource configuration may comprise a sensing effective time duration in which the RF sensing measurements can be performed, a threshold value for determining phase continuity, or a combination thereof. An OFDMA slot may include of a variety of different formats having one or more AGC symbols, example of which is illustrated in FIG. 4C, described above. According to some embodiments, obtaining the sensing resource configuration may simply comprise obtaining a confirmation or acknowledgment of a proposed configuration. Thus, according to some embodiments, obtaining the indication of the sensing resource configuration they comprise sending an indication of a proposed OFDM slot format from the UE to a second UE, and receiving an acknowledgement of the proposed OFDM slot format from the second UE.

Means for performing functionality at block 1510 may comprise a one or more processors 1710, digital signal processor (DSP) 1720, a wireless communication interface 1730, a memory 1760, and/or other components of a UE 1700 as illustrated in the FIG. 17.

At block 1520, the functionality comprises performing, at the UE, RF sensing measurements of one or more transmitted RF signals in the one or more AGC symbols of the OFDM slot, in accordance with the sensing resource configuration. RF sensing measurements may be formed using a transceiver/wireless communications interface of the UE. Moreover, RF sensing measurements may comprise one or more TOA measurements of the one or more transmitted RF signals in the one or more AGC symbols of the OFDM slot.

Means for performing functionality at block 1520 may comprise a one or more processors 1710, digital signal processor (DSP) 1720, a wireless communication interface 1730, a memory 1760, and/or other components of a UE 1700 as illustrated in the FIG. 17.

As noted herein, embodiments may implement one or more additional features, based on desired functionality. For example, as noted with respect to FIG. 8, some embodiments may include performing the RF sensing measurements may be responsive to receiving, at the UE, a trigger message from a network node or a second UE. In such embodiments, the trigger message may be received from the network node via a PDCCH, or the trigger message made received from the second UE via a PSCCH. Additionally or alternatively, according to some embodiments, obtaining the indication of the sensing resource configuration may comprise receiving the sensing resource configuration from a network node. Such embodiments may further comprise sending a report indicative of the RF sensing measurements to the network node. As noted with respect to FIG. 5, some embodiments may further include receiving, prior to sending the report, a reporting configuration at the UE from the network node, wherein sending the report is in accordance with the reporting configuration. Embodiments may further comprise including, in the report, an indication of an AGC state of the UE, a determined phase continuity of the RF sensing measurements, a number of one or more sensed targets, a speed of one or more sensed targets, a location of one or more sensed targets, or a combination thereof. Some embodiments may comprise sending a request for an AGC symbol configuration for a subsequent OFDM slot based at least in part on the RF sensing measurements. In such embodiments, the request for the AGC symbol configuration may include a requested number or length of AGC symbols for the subsequent OFDM slot. As noted with respect to FIGS. 13B and 13C, the requested number or length of AGC symbols may be based at least in part on a subcarrier spacing (SCS) of the subsequent OFDM slot.

As also noted in the embodiments described herein (e.g., with respect to FIGS. 5 and 11), sensing information may be used for subsequent AGC symbol configuration. Thus, some embodiments may further comprise receiving an AGC symbol configuration subsequent to performing the RF sensing measurements, wherein the AGC symbol configuration is indicative of a new number or length of AGC symbols in a subsequent OFDM slot, a new location of one or more AGC symbols an in a subsequent OFDM slot, or a combination thereof. As noted with respect to FIG. 12, according to some embodiments, the AGC symbol configuration may include an identifier of a previously defined OFDM slot format. The AGC symbols themselves may include an RS and/or repeated data symbol, and a gap symbol may comprise any of a variety of types of symbols. Thus, according to some embodiments, the AGC symbol configuration includes an indication of at least one AGC symbol comprising a repeated data channel; at least one AGC symbol comprising a reference signal (RS) channel; at least one gap symbol comprising a repeated data channel, a repeated RS channel, or a blank symbol; or a combination thereof. The AGC symbol(s) comprising the RS and/or repeated data channel may be provided at the same power level as other symbols, thereby enabling AGC without power fluctuation.

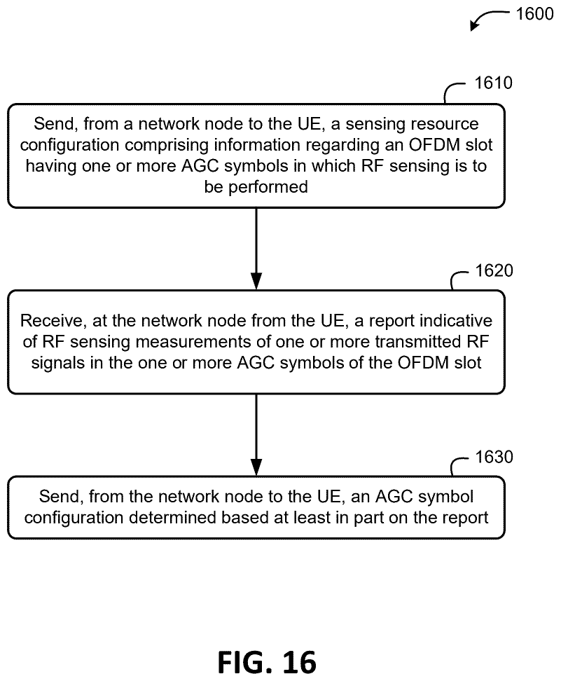

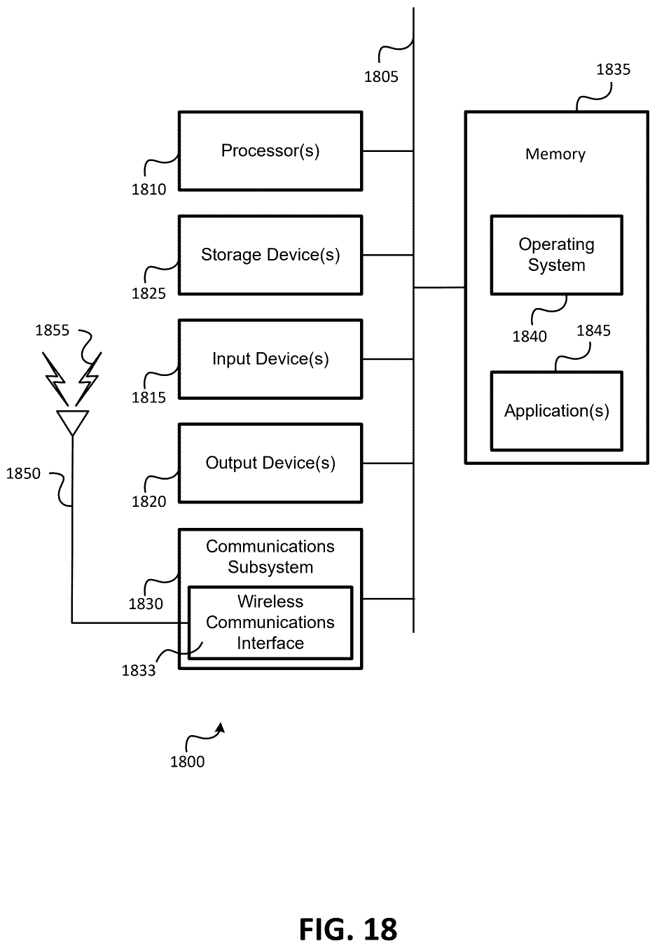

FIG. 16 is a flow diagram of a method 1600 of enabling RF sensing by a UE, according to an embodiment. The method 1600 may comprise aspects of the functionality of a network node, such as a sensing server (e.g., SMF) and/or base station (e.g., gNB). As discussed in the embodiments above. As such, one or more of the operations in the blocks of FIG. 16 may be performed by hardware and/or software components of a computer system. Example components of a pewter system are illustrated in FIG. 18, which is described in more detail below.

At block 1610, the functionality comprises sending, from a network node to the UE, a sensing resource configuration comprising information regarding an OFDM slot having one or more AGC symbols in which RF sensing is to be performed. As noted, the format and/or contents of the sensing resource configuration may vary depending on desired functionality. In some embodiments, the sensing resource configuration may indicate a slot format having the one or more AGC symbols. According to some embodiments, the sensing resource configuration may comprise a sensing effective time duration in which the RF sensing measurements can be performed, a threshold value for determining phase continuity, or a combination thereof.

Means for performing functionality at block 1610 may comprise one or more processors 1810, a communications subsystem 1830 (which may include wireless communication interface 1833), memory 1835 (which may include operating system 1840 and/or one or more applications 1845), and/or other components of a computer system 1800 as illustrated in the FIG. 18.

At block 1620, the functionality comprises receiving, at the network node from the UE, a report indicative of RF sensing measurements of one or more transmitted RF signals in the one or more AGC symbols of the OFDM slot. As noted with respect to FIG. 5, the network node may send the UE a reporting configuration for sensing measurements, in which case the receiving of the report may be in accordance with the reporting configuration. The contents of the report may vary, as previously noted, and may include an AGC state, phase information, and/or other such information. The RF sensing measurements may be made in response to a trigger on the network node, according to some embodiments. As such, embodiments may further comprise sending a trigger message from the network node to the UE prior to receiving the report.

Means for performing functionality at block 1620 may comprise one or more processors 1810, a communications subsystem 1830 (which may include wireless communication interface 1833), memory 1835 (which may include operating system 1840 and/or one or more applications 1845), and/or other components of a computer system 1800 as illustrated in the FIG. 18.

At block 1630, the functionality comprises sending, from the network node to the UE, an AGC symbol configuration determined based at least in part on the report. This may be done in the manner as described, for example, with respect to FIGS. 5 and/or 11. According to some embodiments, the network node may further include, in the AGC symbol configuration, an indication of a new number or length of AGC symbols in a subsequent OFDM slot, a new location of one or more AGC symbols an in a subsequent OFDM slot, or a combination thereof. In such embodiments, the AGC symbol configuration may include an identifier of a previously defined OFDM slot format. The AGC symbol configuration may be provided in response to a request received by the network node from the UE. Moreover, as indicated elsewhere herein, the request may include a requested location and/or number/length of AGC symbols in a slot, which may be based on information obtained from the RF sensing measurements.

Means for performing functionality at block 1630 may comprise one or more processors 1810, a communications subsystem 1830 (which may include wireless communication interface 1833), memory 1835 (which may include operating system 1840 and/or one or more applications 1845), and/or other components of a computer system 1800 as illustrated in the FIG. 18.

FIG. 17 is a block diagram of an embodiment of a UE 1700, which can be utilized as described herein (e.g., in association with the previously described figures), for performing RF sensing (e.g., as a transmitting, receiving, and/or configuring device). In some embodiments, for example, the UE 1700 may comprise, for example, a mobile (e.g., movable/portable) device (e.g., UE, tablet, laptop, vehicle, etc.). In some embodiments, the UE 1700 may comprise a fixed (e.g., immobile) electronic device. It should be noted that FIG. 17 is meant only to provide a generalized illustration of various components, any or all of which may be utilized as appropriate. Furthermore, the functionality of the sensing nodes discussed herein may be executed by one or more of the hardware and/or software components illustrated in FIG. 17.

The UE 1700 is shown comprising hardware elements that can be electrically coupled via a bus 1705 (or may otherwise be in communication, as appropriate). The hardware elements may include a processor(s) 1710 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 1710 may comprise one or more processing units, which may be housed in a single integrated circuit (IC) or multiple ICs. As shown in FIG. 17, some embodiments may have a separate DSP 1720, depending on desired functionality. Location determination and/or other determinations based on wireless communication may be provided in the processor(s) 1710 and/or wireless communication interface 1730 (discussed below). The UE 1700 also can include one or more input devices 1770, which can include without limitation one or more keyboards, touch screens, touch pads, microphones, buttons, dials, switches, and/or the like; and one or more output devices 1715, which can include without limitation one or more displays (e.g., touch screens), light emitting diodes (LEDs), speakers, and/or the like.

The UE 1700 may also include a wireless communication interface 1730, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 1700 to communicate with other devices as described in the embodiments above. The wireless communication interface 1730 may permit data and signaling to be communicated (e.g., transmitted and received) with base stations of a network, for example, via eNBs, gNBs, ng-eNBs, access points, various base stations and/or other access node types, and/or other network components, computer systems, and/or any other electronic devices communicatively coupled with base stations, as described herein. The communication can be carried out via one or more wireless communication antenna(s) 1732 that send and/or receive wireless signals 1734. According to some embodiments, the wireless communication antenna(s) 1732 may comprise a plurality of discrete antennas, antenna arrays, or any combination thereof. The antenna(s) 1732 may be capable of transmitting and receiving wireless signals using beams (e.g., Tx beams and Rx beams). Beam formation may be performed using digital and/or analog beam formation techniques, with respective digital and/or analog circuitry. The wireless communication interface 1730 may include such circuitry.

Depending on desired functionality, the wireless communication interface 1730 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 1700 may communicate with different data networks that may comprise various network types. For example, one such network type may comprise a wireless wide area network (WWAN), which may be a code-division multiple access (CDMA) network, a time division multiple access (TDMA) network, a frequency division multiple access (FDMA) network, an orthogonal frequency division multiple access (OFDMA) network, a single-carrier frequency division multiple access (SC-FDMA) network, a WiMAX (IEEE 802.16) network, and so on. A CDMA network may implement one or more radio access technologies (RATs) such as CDMA2000®, wideband code division multiple access (WCDMA), and so on. CDMA2000® includes IS-95, IS-2000 and/or IS-856 standards. A TDMA network may implement global system for mobile communications (GSM), digital advanced mobile phone system (D-AMPS), or some other RAT. An OFDMA network may employ long-term evolution (LTE), LTE Advanced, fifth generation (5G) new radio (NR), and so on. 5G NR, LTE, LTE Advanced, GSM, and WCDMA are described in documents from 3rd Generation Partnership Project (3GPP). CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 1700 can further include sensor(s) 1740. Sensor(s) 1740 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 1700 may further comprise a sensing unit 1750. The sensing unit 1750 may comprise hardware and/or software components capable of transmitting and/or receiving RF signals (e.g., RS) to detect one or more targets in the manner described herein. The sensing unit 1750 may comprise a standalone component connected with a bus 1705, as illustrated, or may be incorporated into another component (e.g., the wireless indication interface 1730). Further, the sensing unit 1750 may be communicatively coupled with an antenna 1732, which it may share with the wireless communication interface 1730. Additionally or alternatively, the sensing unit 1750 may have its own antenna (not shown). In some embodiments the sensing unit 1750 may be communicatively coupled with multiple antennas or an antenna array capable of sending and/or receiving RF signals via directional beams.

Embodiments of the UE 1700 may also include a Global Navigation Satellite System (GNSS) receiver 1780 capable of receiving signals 1784 from one or more GNSS satellites using an antenna 1782 (which could be the same as antenna 1732). Positioning based on GNSS signal measurement can be utilized to complement and/or incorporate the techniques described herein. The GNSS receiver 1780 can extract a position of the UE 1700, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 1780 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1780 is illustrated in FIG. 17 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1710, DSP 1720, and/or a processor within the wireless communication interface 1730 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 1710 or DSP 1720.

The UE 1700 may further include and/or be in communication with a memory 1760. The memory 1760 can include, without limitation, local and/or network accessible storage, a disk drive, a drive array, an optical storage device, a solid-state storage device, such as a random-access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1760 of the UE 1700 also can comprise software elements (not shown in FIG. 17), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1760 that are executable by the UE 1700 (and/or processor(s) 1710 or DSP 1720 within UE 1700). In some embodiments, then, such code and/or instructions can be used to configure and/or adapt a general-purpose computer (or other device) to perform one or more operations in accordance with the described methods.

FIG. 18 is a block diagram of an embodiment of a computer system 1800, which may be used, in whole or in part, to provide the functions of one or more components and/or devices as described in the embodiments herein, including a server (e.g., sensing server/SMF and/or base station/gNB) in communication with one or more sensing nodes to coordinate RF sensing as described in embodiments herein. This may include, for example, a computer server, personal computer, personal electronic device, or the like. It should be noted that FIG. 18 is meant only to provide a generalized illustration of various components, any or all of which may be utilized as appropriate. FIG. 18, therefore, broadly illustrates how individual system elements may be implemented in a relatively separated or relatively more integrated manner. In addition, it can be noted that components illustrated by FIG. 18 can be localized to a single device and/or distributed among various networked devices, which may be disposed at different geographical locations.

The computer system 1800 is shown comprising hardware elements that can be electrically coupled via a bus 1805 (or may otherwise be in communication, as appropriate). The hardware elements may include processor(s) 1810, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1800 also may comprise one or more input devices 1815, which may comprise without limitation a mouse, a keyboard, a camera, a microphone, and/or the like; and one or more output devices 1820, which may comprise without limitation a display device, a printer, and/or the like.

The computer system 1800 may further include (and/or be in communication with) one or more non-transitory storage devices 1825, which can comprise, without limitation, local and/or network accessible storage, and/or may comprise, without limitation, a disk drive, a drive array, an optical storage device, a solid-state storage device, such as a random-access memory (RAM) and/or read-only memory (ROM), which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1800 may also include a communications subsystem 1830, which may comprise wireless communication technologies managed and controlled by a wireless communication interface 1833, as well as wired technologies (such as Ethernet, coaxial communications, universal serial bus (USB), and the like). The wireless communication interface 1833 may comprise one or more wireless transceivers that may send and receive wireless signals 1855 (e.g., signals according to 5G NR or LTE) via wireless antenna(s) 1850. Thus the communications subsystem 1830 may comprise a modem, a network card (wireless or wired), an infrared communication device, a wireless communication device, and/or a chipset, and/or the like, which may enable the computer system 1800 to communicate on any or all of the communication networks described herein to any device on the respective network, including a User Equipment (UE), base stations and/or other transmission reception points (TRPs), and/or any other electronic devices described herein. Hence, the communications subsystem 1830 may be used to receive and send data as described in the embodiments herein.

In many embodiments, the computer system 1800 will further comprise a working memory 1835, which may comprise a RAM or ROM device, as described above. Software elements, shown as being located within the working memory 1835, may comprise an operating system 1840, device drivers, executable libraries, and/or other code, such as one or more applications 1845, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1825 described above. In some cases, the storage medium might be incorporated within a computer system, such as computer system 1800. In other embodiments, the storage medium might be separate from a computer system (e.g., a removable medium, such as an optical disc), and/or provided in an installation package, such that the storage medium can be used to program, configure, and/or adapt a general-purpose computer with the instructions/code stored thereon. These instructions might take the form of executable code, which is executable by the computer system 1800 and/or might take the form of source and/or installable code, which, upon compilation and/or installation on the computer system 1800 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1. A method of enabling radio frequency (RF) sensing by a user equipment (UE), the method comprising: obtaining, at the UE, an indication of a sensing resource configuration comprising information regarding an orthogonal frequency division multiplexing (OFDM) slot having one or more automatic gain control (AGC) symbols in which RF sensing is to be performed; and performing, at the UE, RF sensing measurements of one or more transmitted RF signals in the one or more AGC symbols of the OFDM slot, in accordance with the sensing resource configuration.
Clause 2. The method of clause 1, wherein the sensing resource configuration comprises: a sensing effective time duration in which the RF sensing measurements can be performed, a threshold value for determining phase continuity, or a combination thereof.
Clause 3. The method of any one of clauses 1-2 wherein performing the RF sensing measurements is responsive to receiving, at the UE, a trigger message from a network node or a second UE.
Clause 4. The method of clause 3 wherein the trigger message is received from the network node via a physical downlink control channel (PDCCH), or the trigger message is received from the second UE via a physical sidelink control channel (PSCCH).
Clause 5. The method of any one of clauses 1-4 wherein obtaining the indication of the sensing resource configuration comprise receiving the sensing resource configuration from a network node.
Clause 6. The method of clause 5 further comprising sending a report indicative of the RF sensing measurements to the network node.
Clause 7. The method of clause 6 further comprising receiving, prior to sending the report, a reporting configuration at the UE from the network node, wherein sending the report is in accordance with the reporting configuration.
Clause 8. The method of any one of clauses 6-7 further comprising including, in the report, an indication of: an AGC state of the UE, a determined phase continuity of the RF sensing measurements, a number of one or more sensed targets, a speed of one or more sensed targets, a location of one or more sensed targets, or a combination thereof.
Clause 9. The method of any one of clauses 1-8 further comprising sending a request for an AGC symbol configuration for a subsequent OFDM slot based at least in part on the RF sensing measurements.
Clause 10. The method of clause 9 wherein the request for the AGC symbol configuration includes a requested number or length of AGC symbols for the subsequent OFDM slot.
Clause 11. The method of clause 10 wherein requested number or length of AGC symbols is based at least in part on a subcarrier spacing (SCS) of the subsequent OFDM slot.
Clause 12. The method of any one of clauses 1-11 further comprising receiving an AGC symbol configuration subsequent to performing the RF sensing measurements, wherein the AGC symbol configuration is indicative of: a new number or length of AGC symbols in a subsequent OFDM slot, a new location of one or more AGC symbols an in a subsequent OFDM slot, or a combination thereof.
Clause 13. The method of clause 12 wherein the AGC symbol configuration includes an identifier of a previously defined OFDM slot format.
Clause 14. The method of any one of clauses 12-13 wherein the AGC symbol configuration includes an indication of: at least one AGC symbol comprising a repeated data channel; at least one AGC symbol comprising a reference signal (RS) channel; at least one gap symbol comprising a repeated data channel, a repeated RS channel, or a blank symbol; or a combination thereof.
Clause 15. The method of any one of clauses 1-14 wherein obtaining the indication of the sensing resource configuration comprises: sending an indication of a proposed OFDM slot format from the UE to a second UE; and receiving an acknowledgement of the proposed OFDM slot format from the second UE.
Clause 16. A method of enabling radio frequency (RF) sensing by a user equipment (UE), the method comprising: sending, from a network node to the UE, a sensing resource configuration comprising information regarding an orthogonal frequency division multiplexing (OFDM) slot having one or more automatic gain control (AGC) symbols in which RF sensing is to be performed; and receiving, at the network node from the UE, a report indicative of RF sensing measurements of one or more transmitted RF signals in the one or more AGC symbols of the OFDM slot; and sending, from the network node to the UE, an AGC symbol configuration determined based at least in part on the report.
Clause 17. The method of clause 16, wherein the sensing resource configuration comprises: a sensing effective time duration in which the RF sensing measurements can be performed, a threshold value for determining phase continuity, or a combination thereof.
Clause 18. The method of any one of clauses 16-17 further comprising sending a trigger message from the network node to the UE prior to receiving the report.
Clause 19. The method of any one of clauses 16-18 further comprising, prior to sending the AGC symbol configuration, receiving a request for the AGC symbol configuration from the UE.
Clause 20. The method of any one of clauses 16-19 further comprising including, in the AGC symbol configuration, an indication of: a new number or length of AGC symbols in a subsequent OFDM slot, a new location of one or more AGC symbols an in a subsequent OFDM slot, or a combination thereof.
Clause 21. The method of any one of clauses 16-20 wherein the AGC symbol configuration includes an identifier of a previously defined OFDM slot format.
Clause 22. A user equipment (UE) comprising: a transceiver; a memory; and one or more processors communicatively coupled with the transceiver and the memory, wherein the one or more processors are configured to: obtain an indication of a sensing resource configuration comprising information regarding an orthogonal frequency division multiplexing (OFDM) slot having one or more automatic gain control (AGC) symbols in which RF sensing is to be performed; and perform, with the transceiver, radio frequency (RF) sensing measurements of one or more transmitted RF signals in the one or more AGC symbols of the OFDM slot, in accordance with the sensing resource configuration.
Clause 23. The UE of clause 22, wherein, to obtain the indication of the sensing resource configuration, the one or more processors are configured to obtain an indication of: a sensing effective time duration in which the RF sensing measurements can be performed, a threshold value for determining phase continuity, or a combination thereof.
Clause 24. The UE of any one of clauses 22-23 wherein one or more processors are configured to perform the RF sensing measurements responsive to receiving, at the UE, a trigger message from a network node or a second UE.
Clause 25. The UE of any one of clauses 22-24 wherein, to obtain the indication of the sensing resource configuration, the one or more processors are configured to receive the sensing resource configuration from a network node using the transceiver.
Clause 26. The UE of any one of clauses 22-25 wherein the one or more processors are further configured to send a request, using the transceiver, for an AGC symbol configuration for a subsequent OFDM slot based at least in part on the RF sensing measurements.
Clause 27. A network node comprising: a transceiver; a memory; and one or more processors communicatively coupled with the transceiver and the memory, wherein the one or more processors are configured to: send, via the transceiver to a user equipment (UE), a sensing resource configuration comprising information regarding an orthogonal frequency division multiplexing (OFDM) slot having one or more automatic gain control (AGC) symbols in which RF sensing is to be performed; and receive, via the transceiver from the UE, a report indicative of RF sensing measurements of one or more transmitted RF signals in the one or more AGC symbols of the OFDM slot; and send, in the transceiver to the UE, an AGC symbol configuration determined based at least in part on the report.
Clause 28. The network node of clause 27, wherein, to send the sensing resource configuration, the one or more processors are configured to send information comprising: a sensing effective time duration in which the RF sensing measurements can be performed, a threshold value for determining phase continuity, or a combination thereof.
Clause 29. The network node of any one of clauses 27-28 wherein the one or more processors are further configured to send a trigger message from the network node, via the transceiver, to the UE prior to receiving the report.
Clause 30. The network node of any one of clauses 27-29 wherein the one or more processors are further configured to receive a request for the AGC symbol configuration from the UE, prior to sending the AGC symbol configuration.
Clause 31. An apparatus having means for performing the method of any one of clauses 1-21.
Clause 32. A non-transitory computer-readable medium storing instructions, the instructions comprising code for performing the method of any one of clauses 1-21.

1. A method of enabling radio frequency (RF) sensing by a user equipment (UE),
the method comprising:
obtaining, at the UE, an indication of a sensing resource configuration comprising information regarding an orthogonal frequency division multiplexing (OFDM) slot having one or more automatic gain control (AGC) symbols in which RF sensing is to be performed; and
performing, at the UE, RF sensing measurements of one or more transmitted RF signals in the one or more AGC symbols of the OFDM slot, in accordance with the sensing resource configuration.

2. The method of claim 1, wherein the sensing resource configuration comprises:
a sensing effective time duration in which the RF sensing measurements can be performed,
a threshold value for determining phase continuity, or a combination thereof.

3. The method of claim 1, wherein performing the RF sensing measurements is responsive to receiving, at the UE, a trigger message from a network node or a second UE.

4. The method of claim 3, wherein:
the trigger message is received from the network node via a physical downlink control channel (PDCCH), or
the trigger message is received from the second UE via a physical sidelink control channel (PSCCH).

5. The method of claim 1, wherein obtaining the indication of the sensing resource configuration comprise receiving the sensing resource configuration from a network node.

6. The method of claim 5, further comprising sending a report indicative of the RF sensing measurements to the network node.

7. The method of claim 6, further comprising receiving, prior to sending the report, a reporting configuration at the UE from the network node, wherein sending the report is in accordance with the reporting configuration.

8. The method of claim 6, further comprising including, in the report, an indication of:
an AGC state of the UE,
a determined phase continuity of the RF sensing measurements,
a number of one or more sensed targets,
a speed of one or more sensed targets,
a location of one or more sensed targets, or a combination thereof.

9. The method of claim 1, further comprising sending a request for an AGC symbol configuration for a subsequent OFDM slot based at least in part on the RF sensing measurements.

10. The method of claim 9, wherein the request for the AGC symbol configuration includes a requested number or length of AGC symbols for the subsequent OFDM slot.

11. The method of claim 10, wherein requested number or length of AGC symbols is based at least in part on a subcarrier spacing (SCS) of the subsequent OFDM slot.

12. The method of claim 1, further comprising receiving an AGC symbol configuration subsequent to performing the RF sensing measurements, wherein the AGC symbol configuration is indicative of:
a new number or length of AGC symbols in a subsequent OFDM slot,
a new location of one or more AGC symbols an in a subsequent OFDM slot, or
a combination thereof.

13. The method of claim 12, wherein the AGC symbol configuration includes an identifier of a previously defined OFDM slot format;
at least one AGC symbol comprising a repeated data channel;
at least one AGC symbol comprising a reference signal (RS) channel;
at least one gap symbol comprising a repeated data channel, a repeated RS channel, or a blank symbol; or a combination thereof.

14. (canceled)

15. The method of claim 1, wherein obtaining the indication of the sensing resource configuration comprises:
sending an indication of a proposed OFDM slot format from the UE to a second UE; and
receiving an acknowledgement of the proposed OFDM slot format from the second UE.

16-21. (canceled)

22. A user equipment (UE) comprising:
a transceiver;
a memory; and
one or more processors communicatively coupled with the transceiver and the memory, wherein the one or more processors are configured to:
obtain an indication of a sensing resource configuration comprising information regarding an orthogonal frequency division multiplexing (OFDM) slot having one or more automatic gain control (AGC) symbols in which RF sensing is to be performed; and
perform, with the transceiver, radio frequency (RF) sensing measurements of one or more transmitted RF signals in the one or more AGC symbols of the OFDM slot, in accordance with the sensing resource configuration.

23. The UE of claim 22, wherein, to obtain the indication of the sensing resource configuration, the one or more processors are configured to obtain an indication of:
a sensing effective time duration in which the RF sensing measurements can be performed,
a threshold value for determining phase continuity, or
a combination thereof.

24. The UE of claim 22, wherein one or more processors are configured to perform the RF sensing measurements responsive to receiving, at the UE, a trigger message from a network node or a second UE.

25. The UE of claim 22, wherein, to obtain the indication of the sensing resource configuration, the one or more processors are configured to receive the sensing resource configuration from a network node using the transceiver.

26. The UE of claim 22, wherein the one or more processors are further configured to send a request, using the transceiver, for an AGC symbol configuration for a subsequent OFDM slot based at least in part on the RF sensing measurements.

27. A network node comprising:
a transceiver;
a memory; and
one or more processors communicatively coupled with the transceiver and the memory, wherein the one or more processors are configured to:
send, via the transceiver to a user equipment (UE), a sensing resource configuration comprising information regarding an orthogonal frequency division multiplexing (OFDM) slot having one or more automatic gain control (AGC) symbols in which RF sensing is to be performed; and
receive, via the transceiver from the UE, a report indicative of RF sensing measurements of one or more transmitted RF signals in the one or more AGC symbols of the OFDM slot; and
send, in the transceiver to the UE, an AGC symbol configuration determined based at least in part on the report.

28-30. (canceled)
